(19) United States
(12) Patent Application Publication
(10) Pub. No.: US 2026/0288545 A1
(43) Pub. Date: Sep. 24, 2026

(54) SYSTEM

(71) Applicant: SoftBank Group Corp., Tokyo (JP)

(72) Inventor: Shiori TAKAHARA, Tokyo (JP)

(73) Assignee: SoftBank Group Corp., Tokyo (JP)

(21) Appl. No.: 19/565,587

(22) Filed: Mar. 13, 2026

(30) Foreign Application Priority Data
Mar. 19, 2025 (JP) 2025-044508

(51) Int. Cl. G06F 9/54; G06N 3/045; H04L 51/02

(52) U.S. Cl. CPC G06F 9/542; G06N 3/045; H04L 51/02; G06F 2209/544

(57) ABSTRACT

A system includes a processor that is configured to register attribute information and preference information of a user, recognize an emotion of the user by using an emotion engine, and adjust information to be subsequently proposed based on the emotion of the user, analyze the registered information, generate a prompt for instructing a generative AI model to propose information based on a result of the analysis, input the prompt into the generative AI model to cause the generative AI model to propose information, automatically place a reservation for the proposed information at an external information source, and notify completion of the reservation via a communication application.

### CROSS-REFERENCE TO RELATED APPLICATION

This application is based on and claims priority under 35 USC 119 from Japanese Patent Application No. 2025-044508 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional information recommendation systems, user preferences are typically registered only as static attribute information or genre preferences, and recommendations are generated without sufficiently considering dynamic emotional states of users. As a result, proposed information is often misaligned with the user's current mood or intent, thereby reducing user satisfaction and engagement. Furthermore, in conventional systems, a user is frequently required to manually perform peripheral operations such as making reservations at external information sources (for example, library systems or content platforms), confirming completion of such reservations, and managing already-read or already-consumed information in separate management applications. This leads to duplicated operations, increased user burden, and a higher likelihood of receiving recommendations that include items already read or consumed. In addition, although historical usage data of the user (such as past selections, reservations, and reading or consumption history) is potentially valuable for improving recommendation quality, existing systems often fail to effectively analyze such histories in combination with emotional states and generative AI models. Consequently, there is a need for a system capable of: (i) dynamically adjusting proposals based on user emotion, (ii) automatically linking to external information sources and communication applications, (iii) automatically registering and excluding already-read information, and (iv) leveraging user history to continuously propose new and more appropriate information.

### SUMMARY

In order to solve the above-described problems, according to one aspect, there is provided a system comprising a processor, wherein the processor is configured to register attribute information and preference information of a user, recognize an emotion of the user by using an emotion engine, and adjust information to be subsequently proposed based on the emotion of the user. The processor is further configured to analyze the registered information, generate a prompt for instructing a generative AI model to propose information based on a result of the analysis, input the prompt into the generative AI model to cause the generative AI model to propose information, automatically place a reservation for the proposed information at an external information source, and notify completion of the reservation via a communication application. In addition, the processor is configured to automatically register information that has been read in a management application based on a processing result at the external information source, and to exclude the information that has been read from proposals generated by the generative AI model. Furthermore, the processor is configured to analyze a history of the user, including at least one of past proposals, reservations, and read or consumed information, and to propose new information based on a result of the analysis. By these means, the system integrates emotional recognition, generative AI-based recommendation, automatic reservation and notification, automatic management of already-read information, and history analysis, thereby reducing user burden, preventing redundant proposals, and improving the relevance and timeliness of the proposed information.

The term “processor” refers to any hardware, firmware, or combination of hardware and software components capable of executing instructions, including but not limited to a central processing unit (CPU), a microcontroller, a graphics processing unit (GPU), an application-specific integrated circuit (ASIC), a programmable logic device, or a distributed collection of such components operating together as a logical processing unit.

The term “user” refers to an individual person or entity that interacts with the system, whose attribute information, preference information, emotional state, history, or other related data are processed by the system to generate and manage information proposals.

The term “attribute information” refers to information indicating inherent or relatively stable characteristics of the user, including but not limited to age, gender, location, occupation, language, and device environment, which may be used to influence or constrain information proposals.

The term “preference information” refers to information indicating likes, dislikes, interests, or priorities of the user with respect to content or items to be proposed, including but not limited to preferred genres, categories, topics, authors, creators, or service types.

The term “emotion engine” refers to a software module, hardware module, or combination thereof that is configured to recognize, estimate, or infer an emotional state of the user based on input data, such as user interactions, biometric data, voice, text, facial expressions, or other sensor data.

The term “emotion of the user” refers to a current or recent affective state or mood of the user, including but not limited to states such as happiness, sadness, interest, boredom, stress, or relaxation, which may be represented numerically, categorically, or by multidimensional parameters.

The term “information to be subsequently proposed” refers to one or more pieces of content, items, or recommendations that are to be presented to the user after the user's emotion or other conditions have been evaluated, and whose selection or ranking is influenced by said emotion or conditions.

The term “registered information” refers to data stored by the system in association with the user, including at least attribute information and preference information, and optionally including historical usage information and other user-related data.

The term “analyze” or “analysis” refers to processing operations performed by the processor on collected or registered data, including but not limited to filtering, classification, clustering, scoring, pattern recognition, inference, or any statistical or machine-learning-based computation that produces an analysis result used for subsequent processing.

The term “prompt” refers to a text, token sequence, structured data, or other input format provided to a generative AI model, which specifies or constrains a task, a query, a context, or conditions for causing the generative AI model to propose information.

The term “generative AI model” refers to a machine learning model configured to generate outputs such as text, rankings, recommendations, or other data based on an input prompt, and may include, for example, a large language model, a generative neural network, or another generative model trained on content or behavioral data.

The term “propose information” refers to causing the system, via the generative AI model, to select, generate, or recommend one or more items of content or data, such as books, articles, media, services, or other resources, for presentation or use by the user.

The term “external information source” refers to any system, service, or platform external to the claimed system that provides or manages content, items, or resources to be reserved or accessed, including but not limited to library systems, content distribution platforms, e-commerce systems, or subscription services.

The term “reservation” or “place a reservation” refers to causing the system to request, via an interface with an external information source, that a specific item of information, such as a book or content item, be held, allocated, or scheduled for the user for later access, borrowing, purchase, or consumption.

The term “communication application” refers to a messaging, notification, or communication service or software, including but not limited to email clients, instant messaging applications, push notification services, or chat platforms, used to transmit reservation completion or other messages from the system to the user.

The term “management application” refers to an application or service configured to store, organize, and present a list or history of information items related to the user, including but not limited to a reading management app, content consumption tracker, or library-history manager.

The term “information that has been read” refers to any content item or information that the user has completed or consumed to a predetermined degree, such as a book that has been returned to the library, a digital article that has been fully read, or other content that the system or an external information source records as completed.

The term “exclude” refers to the operation of preventing certain information items, such as information that has been read, from being selected, ranked, or output as part of proposals generated by the generative AI model.

The term “history of the user” refers to data representing past behavior or interactions of the user with respect to information items, including but not limited to past proposals, accepted recommendations, reservations, loans, returns, purchases, ratings, or read or consumed items, which is used as input for analysis and future proposals.

The term “new information” refers to information items proposed to the user that differ from information that has already been read or previously proposed and consumed, and that are determined, based on analysis, to be novel or not yet completed by the user.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

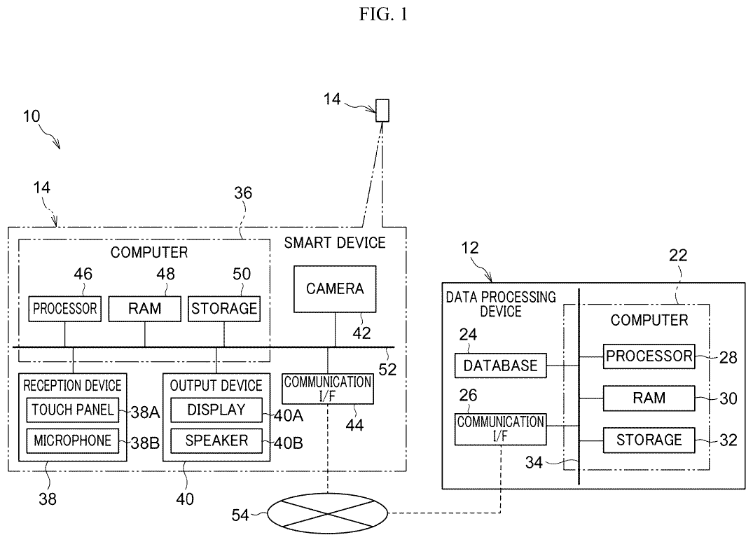

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

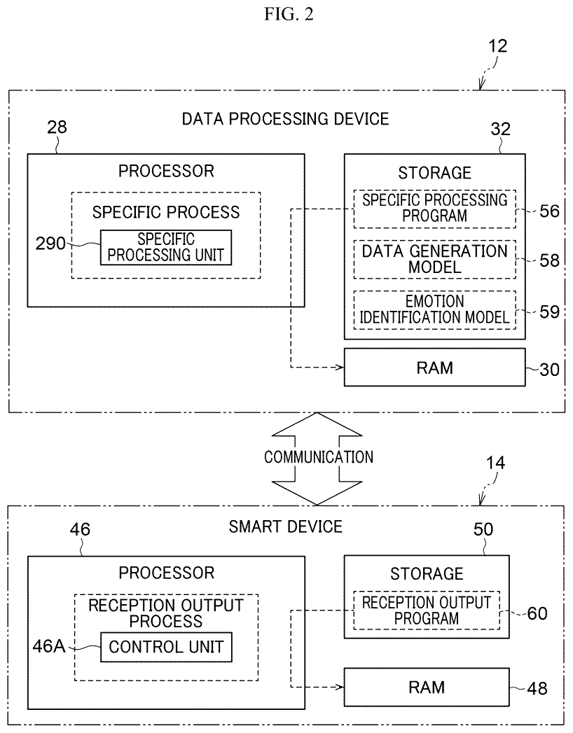

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional information recommendation systems typically rely on manually designed recommendation rules or static machine learning models that use limited user profile information, such as basic demographic attributes and coarse-grained preference categories. These systems often generate generic recommendations that are insufficiently tailored to the user's current context, and they do not effectively exploit the capabilities of generative AI models. Furthermore, such systems generally treat recommendation and downstream execution (for example, reservation, acquisition, or registration with an external service) as separate, loosely coupled processes. As a result, a user is required to manually transition from viewing recommended information to performing concrete actions on external information sources, leading to fragmented workflows, increased latency, and user burden.

In addition, many existing systems do not adequately incorporate a user's emotional state or fine-grained behavior history into the recommendation pipeline. Even when some form of emotion recognition is employed, it is often limited to superficial adaptation of display content, and is not integrated into the core data processing flow that generates inputs for an AI model. This lack of tight integration between attribute information, preference information, emotion information, and behavior history information prevents the system from dynamically and precisely adjusting its recommendations in response to changes in the user's state and usage patterns.

Moreover, even when a generative AI model is used to propose information, conventional approaches frequently send simplistic prompts that merely restate basic user preferences. They do not construct structured, context-rich prompt sentences that reflect accumulated management information, such as which recommendations have already been reserved, acquired, or viewed. Consequently, generative AI models may repeatedly propose the same or similar information, resulting in redundancy, reduced novelty, and degradation of overall system efficiency.

From a computer technology standpoint, there is a technical problem in how to architect a server-side processing pipeline that (i) collects and unifies heterogeneous user-related data (attributes, preferences, emotional states, behavior histories, and external processing results), (ii) transforms that data into optimized prompt sentences for a generative AI model, (iii) automatically orchestrates external information source interactions based on AI-generated output, and (iv) enforces exclusion of processed or viewed items in subsequent AI proposals. Without such an integrated architecture, system resources are wasted by repeatedly querying external information sources for already-processed items, network and computation costs are increased by generating redundant recommendations, and the user experience suffers from repetitive and low-novelty suggestions.

Accordingly, there is a need for an improved computer-implemented system that uses a processor to tightly couple user state recognition (including emotion analysis), structured prompt sentence generation for a generative AI model, automated interaction with external information sources, and management information-based control of subsequent recommendations. Such a system should improve the efficiency and effectiveness of recommendation processing on the server side, reduce unnecessary network and computation overhead, and provide dynamically updated, high-novelty information proposals to the user.

The specific processing by the specific processing unit 290 of the data processing device 12 in Example 1 is realized by the following means.

The present invention provides a server comprising a processor and a storage device, the processor being configured to receive attribute information and preference information of a user from a communication terminal, register the attribute information and the preference information in the storage device, recognize an emotional state of the user by using an emotion analysis function, and store emotion information representing the emotional state in association with the attribute information and the preference information in the storage device; analyze the attribute information, the preference information, and the emotion information stored in the storage device, and automatically generate, based on an analysis result, a prompt sentence that describes at least part of the attribute information, the preference information, and the emotion information in a natural language as input data for a generative AI model; transmit inquiry data including the prompt sentence to the generative AI model, acquire a generated result from the generative AI model, analyze the generated result, and generate, as structured data, a set of information candidates to be presented to the user; automatically generate request data for causing an external information source to execute a reservation process or an acquisition process, based on identification information corresponding to each information candidate included in the set of information candidates, and communicate with the external information source to automatically execute the reservation process or the acquisition process; register, as management information in the storage device, a result of the reservation process or the acquisition process acquired from the external information source, generate notification content to be presented to the user based on the management information and the set of information candidates, and transmit the notification content to the communication terminal via a communication application; and generate control information for excluding, from subsequent automatic generation of the prompt sentence and from subsequent information proposal by the generative AI model, at least one information candidate determined to be processed or viewed based on the management information, and control the information proposal by using the control information. This enables an integrated, computer-implemented recommendation architecture in which the server dynamically constructs context-rich prompt sentences for a generative AI model based on comprehensive user-related data, automatically executes reservation and acquisition processes with external information sources for AI-generated information candidates, maintains management information reflecting processing and viewing states, and uses such management information to suppress redundant proposals and preferentially provide high-novelty information, thereby improving computational efficiency, reducing unnecessary network and processing overhead, and enhancing the technical quality and responsiveness of the recommendation system.

The term “system” refers to a combination of at least one hardware device and software modules that cooperatively execute the claimed processing, including receiving user-related data, generating prompt sentences, interacting with a generative AI model, and performing external information source processing.

The term “processor” refers to one or more hardware processing units, such as a central processing unit or other computation circuitry, configured to execute instructions that implement the functions recited in the claims.

The term “storage device” refers to one or more computer-readable media, such as a memory device or a non-volatile storage device, configured to store data including attribute information, preference information, emotion information, management information, and program instructions.

The term “communication terminal” refers to an information processing device operated by a user, such as a portable device or a stationary device, configured to transmit user-related data to the server and to receive notifications or information candidates from the server.

The term “user” refers to a person or an entity that interacts with the system via the communication terminal and for whom attribute information, preference information, emotion information, behavior history information, and management information are collected and processed.

The term “attribute information” refers to profile data associated with the user, including at least one of demographic data, environmental data, or device-related data, which is used as part of the context for generating information proposals.

The term “preference information” refers to data representing interests, likes, dislikes, or priority categories of the user regarding content, goods, services, or activities, which is utilized to tailor information candidates.

The term “emotion analysis function” refers to a software-implemented function, executable by the processor, that receives one or more inputs related to the user and outputs emotion information indicating an estimated emotional state of the user.

The term “emotional state” refers to a psychological condition of the user, such as happiness, sadness, excitement, or fatigue, inferred by the emotion analysis function at a particular time.

The term “emotion information” refers to data representing an estimation or classification of the user's emotional state, which is stored in association with the attribute information and the preference information.

The term “analysis result” refers to a result obtained by processing, by the processor, at least the attribute information, the preference information, the emotion information, or behavior history information, and used as a basis for generating a prompt sentence or controlling information proposals.

The term “prompt sentence” refers to a text sequence expressed in a natural language and generated by the processor based on at least the attribute information, preference information, and emotion information, the text sequence being used as input data for a generative AI model.

The term “generative AI model” refers to an artificial intelligence model that receives the prompt sentence as input and outputs generated data including at least proposed information candidates, the model being implemented by machine learning such as a neural network.

The term “inquiry data” refers to request data generated by the processor for input to the generative AI model, the request data including at least the prompt sentence and optional generation parameters.

The term “generated result” refers to data output from the generative AI model in response to the inquiry data, including text data or structured data representing proposed information candidates.

The term “information candidate” refers to a unit of proposed information, such as a content item, a product, a service, or an activity, selected or generated based on the generated result of the generative AI model for potential presentation to the user.

The term “structured data” refers to data formatted according to a defined schema, such as a list or a record set, in which each information candidate is represented by fields including at least identification information and descriptive information.

The term “identification information” refers to data used to uniquely or specifically identify an information candidate for the purpose of execution of a reservation process or an acquisition process in an external information source.

The term “external information source” refers to an information processing system or service distinct from the server, accessible via a communication network, and configured to provide data or execute processes related to content, goods, services, or activities.

The term “reservation process” refers to a process executed in the external information source to reserve a resource, content, good, or service associated with an information candidate for the user.

The term “acquisition process” refers to a process executed in the external information source to obtain, purchase, retrieve, or otherwise acquire a resource, content, good, or service associated with an information candidate.

The term “request data” refers to data generated by the processor to request the external information source to execute the reservation process or the acquisition process with respect to a particular information candidate.

The term “management information” refers to data stored in the storage device that records at least results of the reservation process or the acquisition process, viewing states, and other status information related to the processing of information candidates.

The term “notification content” refers to information generated by the processor for presentation to the user, the information indicating at least the information candidates and results of reservation or acquisition processes, and being transmitted to the communication terminal.

The term “communication application” refers to an application program or service used to transmit and receive data between the server and the communication terminal, including at least the notification content.

The term “control information” refers to data generated by the processor to define exclusion conditions or modification conditions for subsequent prompt sentence generation and subsequent information proposals by the generative AI model.

The term “processed information candidate” refers to an information candidate for which at least one of the reservation process, the acquisition process, or another external processing has been completed, as recorded in the management information.

The term “viewed information candidate” refers to an information candidate that has been presented to the user and determined, based on management information or behavior history information, to have been viewed or confirmed by the user.

The term “behavior history information” refers to data representing the user's past interactions with the system or external information sources, including at least operations performed on information candidates, viewing actions, and reservation or acquisition actions.

The term “constraint condition” refers to a condition included in or applied to the prompt sentence that restricts or guides the generative AI model's output, such as exclusion of specific categories, items, or previously processed or viewed information.

The term “description content of the prompt sentence” refers to a part or all of the textual content of the prompt sentence that describes user-related conditions, desired outputs, or constraints for the generative AI model.

The term “output format of the prompt sentence” refers to a specification in the prompt sentence that defines how the generative AI model should structure or format its output, including data structure, field names, or representation style.

The term “high novelty information” refers to information candidates that are determined, based on at least the behavior history information and the management information, not to overlap with or substantially duplicate information previously reserved, acquired, or viewed by the user.

In one embodiment, a server implements the claimed invention as a network-connected computer system including at least one processor, a main memory, a non-volatile storage device, and a network interface. The server executes an operating system such as a general-purpose server operating system and application software including a web server, an application server, a database management system, and a generative AI model client module. For example, the server uses a web server, an application framework such as a server-side framework, a relational or document-oriented database management system, and a REST client library for calling an external generative AI model. The server also communicates with one or more external information sources, such as content catalog systems or reservation systems, via a communication network.

A terminal operates as a user-facing device such as a smartphone, tablet, or personal computer, executing a user interface application implemented as a native application or a web application running in a browser. The terminal includes a processor, a display, input devices (for example, a touchscreen or keyboard), local memory, and a communication interface. The terminal provides input screens for a user to enter attribute information and preference information, and the terminal transmits these data items to the server as structured messages via a secure network protocol.

A user operates the terminal to provide information such as age, region, preferred language, content categories of interest, and specific creators or titles favored by the user. The user can also interact with recommendation results displayed on the terminal, select information candidates of interest, and trigger follow-up operations such as reservation or acquisition through commands sent from the terminal to the server. The user does not need to directly access or configure the generative AI model; instead, the server automatically manages generation and refinement of prompt sentences according to the user's accumulated data.

The server stores attribute information, preference information, emotion information, management information, and behavior history information in a database. In one concrete configuration, the server uses a relational database table structure including, for example, a user table storing user identifiers and stable profile information, a preference table storing multiple preference records associated with each user, an emotion table storing time-stamped emotion states for each user, a recommendation table storing information candidates, and a management table storing reservation states, acquisition states, and viewed states. Each table is indexed by user identifiers and record identifiers to enable fast retrieval of relevant records when constructing a prompt sentence.

The server implements an emotion analysis function as a software module that receives sensor-derived or interaction-derived data and outputs emotion information. In one embodiment, the server receives voice data, textual messages, or interaction patterns (for example, response time, selection density, and scrolling speed) from the terminal. The server then converts these inputs into feature vectors and applies a trained neural network classifier, such as a recurrent neural network or a transformer-based classifier, to infer an emotional state category (for example, happy, neutral, frustrated) and an associated confidence score. The server stores the emotion information in the emotion table, associating it with a user identifier and a timestamp.

The server uses this stored emotion information, together with attribute information and preference information, as input to a prompt generation module. The server implements the prompt generation module as a deterministic algorithm that transforms structured data into a prompt sentence in natural language. The server employs a set of templates and rule-based transformations that are not merely hard-coded business rules, but are designed to produce prompt sentences optimized for the generative AI model's internal tokenization and decoding behavior. For example, the server arranges conditions in a fixed order, uses canonical phrasing that aligns with the generative model's training distribution, and inserts explicit instructions regarding output structure to facilitate robust parsing of the AI output.

In one example, the server generates a prompt sentence such as:

“The user is a 35-year-old reader who prefers mystery novels and especially likes works by a certain author. The user is currently estimated to be in a neutral emotional state. Please recommend 10 mystery novels that are similar in style and theme to the works preferred by the user. Output the result as a list, where each item includes a title, a creator, and a short explanation of why the item is suitable for this user. Avoid including items that have already been reserved, acquired, or viewed by the user in the past.”

In another example, the server generates a prompt sentence for audiovisual content such as: “The user is a 20-year-old viewer who prefers science fiction movies with complex plots and minimal action scenes. The user is currently estimated to be slightly tired. Please recommend 5 science fiction movies that match these conditions, and for each movie, provide the title, the main characteristics of the story, and a brief reason why it is appropriate for a viewer who is slightly tired and prefers complex plots.”

In yet another example related to learning content, the server generates a prompt sentence such as: “The user is a high school learner who likes mathematics and is preparing for standardized examinations. The user prefers explanation-oriented content with many worked examples. The user is currently estimated to be moderately motivated. Please recommend 5 online learning resources for introductory calculus that match these conditions, and describe for each resource the topics covered, the style of explanation, and why it is suitable for a motivated high school learner.”

The server implements a generative AI model client module that communicates with a generative AI model deployed either on a remote inference service or on a local acceleration device. In one embodiment, the generative AI model is a transformer-based neural network comprising an embedding layer, multiple self-attention layers, feedforward layers, and a final output layer. The server formats the prompt sentence into an API request message, including generation parameters such as maximum output length, sampling temperature, and penalty terms for repetition. The server transmits this request via a network interface to the AI inference service and receives the generated result as a text string.

The server does not treat the generative AI model as a black box; instead, the server is aware of the model's tokenization characteristics and decoding strategy. For example, the server may set a lower sampling temperature when the prompt sentence includes strict formatting constraints, in order to reduce variance in the output and improve parsing reliability. The server may also set a top-k or nucleus sampling parameter to balance diversity and consistency of recommendations. These technical controls on generation parameters allow the server to improve computational efficiency by reducing the need for re-queries and post-hoc filtering.

The server parses the generated result using a parser module tailored to the prompt sentence's requested output structure. The server uses regular expressions, delimiters, and field markers to identify individual information candidates and to extract titles, creators, reasons for recommendation, and optional identifiers. The server maps these fields into internal data structures, such as records in the recommendation table. The server then cross-references each information candidate against the management table, which tracks previously reserved, acquired, or viewed items. By comparing identifiers or similarity measures (for example, using normalized string comparison or vector embeddings of titles and creators), the server filters out redundant entries.

The server creates management information records for each information candidate that passes the filtering operation. The management information includes fields such as candidate identifier, user identifier, recommendation timestamp, processing state (unprocessed, reserved, acquired, viewed), and links to external information source identifiers such as catalog identifiers or reservation identifiers. The server also constructs control information that encodes constraints for future prompt sentences, such as lists of identifiers to exclude and conditions limiting repeated recommendations within a predefined time window.

The server uses these internal data structures to control subsequent recommendations in a non-trivial way that goes beyond simple rule-based exclusion. For example, the server can compute a novelty score for each information candidate based on the user's behavior history and the similarity between new candidates and previously consumed items. The server can also apply a decay function to reduce the influence of older behavior history entries over time. By embedding these computed metrics into the prompt sentence, the server guides the generative AI model to propose information candidates that optimize a multi-objective function including novelty, relevance, and diversity, thus improving the technical performance of the overall system.

The server uses the management information and identification information to interact automatically with external information sources. The server constructs request data messages according to external API specifications, including identifiers extracted from or derived from the AI-generated content. For example, if the information candidate is a published work, the server may query an external catalog to obtain a unique identifier and then send a reservation request including the user identifier and time preferences. The server processes responses from the external information sources, updates the management table with the results of reservation or acquisition processes, and generates notification content that reflects these results clearly to the user.

The server transmits notification content to the terminal using a communication application such as a messaging protocol client, push notification framework, or dedicated in-app messaging mechanism. The notification content includes information such as “three recommended items have been successfully reserved” or “one of the recommended items is currently unavailable,” along with links or identifiers allowing the terminal to retrieve detailed status information from the server. Because the server maintains a unified management table and uses it when generating future prompt sentences, the server suppresses redundant proposals of items that have already been processed or rejected, thereby reducing network traffic, decreasing the number of external API calls, and lowering computational load both on the server and on external systems.

The terminal renders the recommended information candidates and notification content in user interface components, such as lists, detail views, and confirmation dialogs. The terminal allows the user to select one or more information candidates and to issue commands such as “reserve,” “acquire,” “add to favorites,” or “ignore.” The terminal transmits these selections to the server, which updates the management information accordingly and may also trigger additional prompt sentence generation if the user requests further recommendations.

This architecture provides a technical improvement over conventional systems in several ways. First, the server uses a structured database schema and a dedicated prompt generation module to construct prompt sentences that encode fine-grained constraints and state information. This reduces the need for manual curation of prompts and improves the reproducibility of AI outputs, leading to fewer parsing errors and less reprocessing. Second, the server integrates emotion information and behavior history information into the prompt sentence and subsequent control information, which allows the generative AI model to produce outputs that are better aligned with the user's current state, reducing the number of irrelevant results. This, in turn, reduces both processing time and bandwidth usage because fewer recommendation cycles are necessary to arrive at satisfactory results.

Third, the server's management information and control information provide a feedback loop that systematically excludes processed and viewed items from subsequent recommendations. This is not a mere automation of human filtering: the server uses precise identifiers, similarity metrics, and prompt constraints to alter the statistical distribution of tokens generated by the generative AI model. As a result, the model's inference workload is naturally focused on unexplored regions of its learned representation space, which improves diversity and novelty of results without increasing the number of inference calls. Fourth, the server's automatic integration with external information sources converts the generative AI model's abstract outputs into concrete, actionable processes within real-world systems, such as reservation platforms or acquisition platforms, thereby tightly coupling AI inference with hardware and network resources.

In other embodiments, the server may incorporate additional algorithmic components such as vector search engines or clustering modules to group similar information candidates and to further refine control information. The server may change the architecture of the generative AI model, for example by using an encoder-decoder transformer instead of a decoder-only transformer, or by fine-tuning a base model on domain-specific corpora that contain structured recommendation patterns. The server may employ different learning methods for the emotion analysis function, such as supervised learning with cross-entropy loss, semi-supervised learning with pseudo-labels, or transfer learning from large-scale emotion recognition datasets.

In a further embodiment, the server may execute data augmentation techniques when training or updating the generative AI model or the emotion analysis model, such as synonym replacement, paraphrasing, noise injection, or time-shifted sampling of behavior history sequences. The server may also perform periodic analysis of error patterns, such as misclassified emotions or incorrectly formatted AI outputs, and adjust its prompt generation rules or decoding parameters accordingly to reduce the error rate.

The user can employ the system in various domains, such as media recommendation, educational content selection, travel planning, or resource booking. Regardless of the domain, the same underlying technical configuration applies: the server accumulates heterogeneous user-related data in a structured form, transforms the data into an optimized prompt sentence tailored to a generative AI model, parses and structures the generated results, automatically coordinates with external information sources, and updates management information and control information to guide subsequent AI inferences. This closed-loop architecture yields technical effects including improved computational efficiency, reduced network traffic, enhanced data management, and increased accuracy and novelty of recommendations, thereby providing a concrete improvement to computer technology rather than a mere automation of human decision-making.

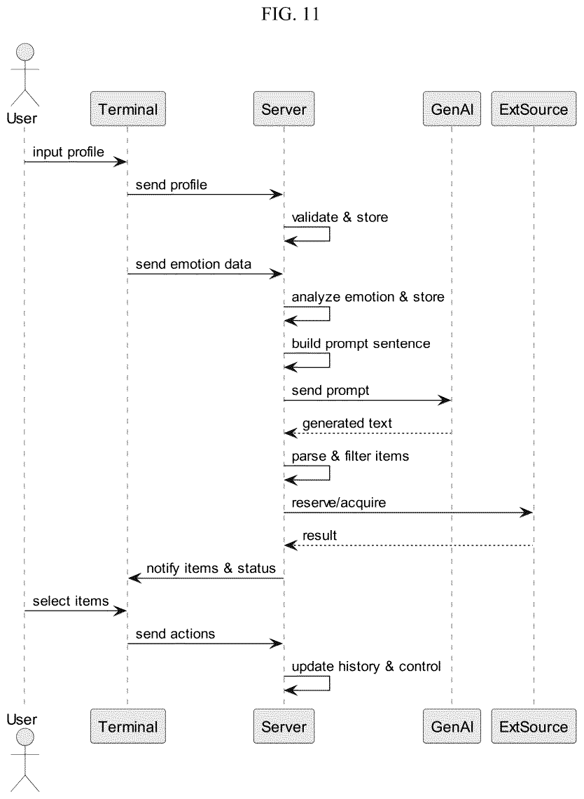

The following describes the processing flow using FIG. 11.
Step 1:

The user operates the terminal to input attribute information and preference information.

The terminal displays input fields on a graphical user interface, and the user enters data such as age, region, preferred language, and categories of interest, and further enters specific preferences such as “likes mystery novels” or “likes works by a particular creator.”

The terminal uses a local validation routine to check that required fields are filled and that formats (for example, numeric, string, language code) are correct.

Input: raw keystrokes and touch events from the user.

The terminal converts these events into structured data objects, serializes the objects into a message format such as JSON, and attaches a user identifier.

Output: a structured user profile message containing attribute information and preference information.
Step 2:

The terminal transmits the structured user profile message to the server.

The terminal establishes a secure communication channel, for example via HTTPS, and sends a request to a predefined server endpoint.

Input: the structured user profile message created in Step 1.

The terminal embeds the message in the body of a network request, adds authentication tokens if necessary, and sends the request over the network interface.

Output: a network packet stream carrying the user profile message to the server.
Step 3:

The server receives the user profile message and validates the included data.

The server uses a web server component to accept the network request and forwards the request to an application module.

Input: the structured user profile message and associated headers.

The server parses the message body, maps the JSON fields into in-memory objects, and runs a validation algorithm that checks data types, ranges, and required fields.

The server discards or normalizes invalid entries, performs basic canonicalization such as trimming whitespace and converting character encodings, and generates an error response if critical fields are missing.

Output: a normalized and validated user profile object stored temporarily in memory.
Step 4:

The server registers the validated attribute information and preference information in a storage device.

The server uses a database management system to persist the data into tables or collections linked to the user identifier.

Input: the normalized user profile object from Step 3.

The server executes insert or update operations, converting the in-memory object into database records, assigning or updating keys, and committing the transaction.

The server may also create index entries for frequently queried fields such as category codes or language codes to speed up later retrieval.

Output: stored attribute records and preference records associated with the user in the storage device.
Step 5:

The server acquires data related to the user's emotional state and generates emotion information.

The terminal may send sensor-derived data, text messages, or interaction metrics (for example, response times and scroll speeds) to the server, and the server feeds these inputs into an emotion analysis function.

Input: user interaction data or sensor data, along with the user identifier.

The server converts the raw data into feature vectors by applying preprocessing operations such as normalization, tokenization, or temporal aggregation.

The server then applies a trained neural network classifier or other machine learning model to the feature vectors and computes probabilities for multiple emotional categories.

The server selects one or more categories with the highest probability and assigns a confidence score, forming emotion information.

Output: emotion information specifying the estimated emotional state and associated confidence, linked to the user.
Step 6:

The server stores the emotion information in association with the user's attribute information and preference information.

The server writes a new record into an emotion information table, referencing the user identifier and including a timestamp, the emotional category, and the confidence score.

Input: emotion information from Step 5 and user identifier from the stored profile.

The server executes a database insert operation, ensuring that the emotion record can be joined with the attribute and preference records via the user identifier.

Output: persisted emotion records linked to the user in the storage device.
Step 7:

The server retrieves attribute information, preference information, and emotion information and analyzes them to prepare for prompt generation.

The server issues database queries to obtain current records for a given user identifier, and also retrieves management information such as processed or viewed items.

Input: user identifier and query parameters specifying which tables and fields to read.

The server joins the retrieved records, aggregates repeated preferences, applies weighting factors based on recency or frequency, and combines this result with the latest emotion information.

The server generates an analysis result object that summarizes the user's current context, including main categories of interest, specific favored creators, and current emotional state.

Output: a consolidated analysis result object representing the user's context.
Step 8:

The server generates a prompt sentence in natural language based on the analysis result.

The server uses a prompt generation module that applies templates and rule-based formatting rules to transform the structured analysis result into a text sequence.

Input: the analysis result object from Step 7, including attribute fields, preference fields, emotion fields, and management constraints.

The server selects an appropriate template according to the content domain (for example, literature, audiovisual media, educational content) and fills the template slots with concrete values.

The server also incorporates constraints derived from management information, such as instructions to exclude previously reserved or viewed items and to produce a specified number of recommendations.

Output: a prompt sentence that describes the user's context and desired output, in natural language text.
Step 9:

The server constructs inquiry data for a generative AI model based on the prompt sentence and generation parameters.

The server wraps the prompt sentence into an API request structure and sets parameters such as maximum token count, sampling temperature, and diversity constraints.

Input: the prompt sentence from Step 8 and configuration parameters stored in the server.

The server encodes the text as required by the AI service interface, attaches authentication data, and forms a complete request message.

Output: inquiry data ready to be transmitted to the generative AI model.
Step 10:

The server transmits the inquiry data to the generative AI model and receives a generated result.

The server sends the request via a network interface to an AI inference service or to a local inference engine and waits for a response.

Input: the inquiry data created in Step 9.

The generative AI model performs internal tokenization, neural network inference, and decoding, and then returns generated text.

The server receives the response, extracts the generated text field, and verifies the response status.

Output: a generated result text that contains proposed information candidates in natural language form.
Step 11:

The server parses the generated result text and converts it into structured data.

The server applies parsing rules consistent with the format requested in the prompt sentence, such as list markers or section headers.

Input: the generated result text from Step 10.

The server identifies individual items, extracts textual segments that correspond to titles, creators, and reasons for recommendation, and maps them into internal record structures.

If the prompt requested a fixed number of items, the server truncates or filters the parsed list to match that number, and marks any incomplete items as invalid.

Output: a structured set of information candidate records, each with defined fields.
Step 12:

The server cross-references the structured set of information candidates with existing management information and filters out redundant candidates.

The server uses identification information such as titles or identifiers to compare against stored records of previously reserved, acquired, or viewed items.

Input: the set of information candidate records from Step 11 and management information retrieved from the storage device.

The server performs matching operations, for example exact string matching or similarity scoring, and excludes candidates that overlap with processed or viewed entries according to predefined thresholds.

Output: a filtered set of information candidate records that are considered new or relevant for the user.
Step 13:

The server generates control information for use in subsequent prompt sentences and information proposals.

The server analyzes which candidates have been filtered out, which candidates remain, and how these relate to the user's behavior history and management states.

Input: the filtered information candidate set from Step 12, management information, and behavior history information.

The server computes exclusion lists, novelty scores, and time-based windows, and encodes these as control information that can be referenced by the prompt generation module.

Output: updated control information specifying exclusion conditions and preferred ranges for future recommendations.
Step 14:

The server initiates reservation or acquisition processing with external information sources for one or more information candidates.

The server selects candidates eligible for automatic processing and constructs request data messages in the format required by external APIs.

Input: the filtered information candidate records from Step 12 and mapping rules for external systems.

The server inserts identification information and user identifiers into the request payloads, sends the requests over the network, and waits for responses from external information sources.

Output: response messages from external information sources indicating success, failure, or additional status details for each requested reservation or acquisition.
Step 15:

The server updates management information based on the responses from external information sources.

The server interprets status codes and message bodies returned by the external systems and translates them into internal state changes.

Input: response messages from Step 14 and existing management records.

The server modifies or creates records in the management table, setting state fields such as “reserved,” “acquired,” or “failed,” and storing associated timestamps and external identifiers.

Output: updated management information that accurately reflects the current processing state of each information candidate.
Step 16:

The server generates notification content summarizing the recommendations and external processing results and transmits this content to the terminal.

The server assembles textual descriptions for each candidate, including whether it has been successfully reserved or acquired and what next actions are available to the user.

Input: the filtered information candidate set from Step 12 and the updated management information from Step 15.

The server formats the notification content as a message or document, embeds links or identifiers for further detail retrieval, and sends the content to the terminal using a communication application protocol.

Output: notification content delivered to the terminal for display.
Step 17:

The terminal receives the notification content and renders it to the user, and the user provides further selections or feedback.

The terminal decodes the message, updates the user interface, and displays lists of information candidates along with their statuses and available actions.

Input: notification content from Step 16.

The user reviews the presented items, selects specific candidates, and issues commands such as confirmation of reservation, rejection, or request for more recommendations.

The terminal captures these commands as structured interaction data and prepares a new request message.

Output: user interaction data and command messages to be sent back to the server.
Step 18:

The terminal transmits the user interaction data to the server, and the server updates behavior history information accordingly.

The terminal sends the user's selections and commands to the server via the same secure communication mechanism used previously.

Input: structured interaction data representing user actions on recommended items.

The server receives this data, translates it into behavior events, and stores these events in a behavior history table, including fields such as event type, time, and related candidate identifiers.

Output: updated behavior history information, which will be used as input for future analysis, prompt generation, and control information updates.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional information recommendation systems and content delivery systems suffer from several technical limitations at the level of computer architecture, data processing, and model control. First, in many existing systems, a recommendation engine operates independently of content acquisition and usage history management. As a result, a server repeatedly recommends digital content that has already been acquired or consumed, thereby causing unnecessary data processing, redundant network traffic, and inefficient utilization of storage resources. This redundancy increases the computational load on the server and leads to an increased number of cycles in which the same content is fetched, evaluated, and presented, without improving the effectiveness of the overall information processing.

Second, when a generative AI model is employed to generate recommendation information, conventional approaches often pass only user preference information as input and do not explicitly encode system-level constraints, such as exclusion of already-acquired or already-read content, into the prompt sentence. In such architectures, post-processing logic on the server must repeatedly filter out unsuitable items from the model output. This causes an unnecessary increase in CPU and memory usage for text parsing and list comparison, and leads to additional database queries to compensate for the fact that constraints were not applied at the model input stage. The lack of tight coupling between prompt construction and usage history management degrades the efficiency and controllability of the generative AI model within the overall computing system.

Third, in many known systems, the linkage between recommendation results and automatic acquisition of digital content from external sources is only loosely implemented. Recommendation results are often treated as unstructured text that must be manually interpreted, or processed in an ad-hoc way by separate scripts, in order to trigger purchase or download operations at external providers. This absence of structured management information directly usable for automatic acquisition forces the server to perform additional parsing and lookup steps each time a recommendation is acted upon. Consequently, the server incurs increased latency and complexity in orchestrating API calls to external content providers, and the robustness of the system decreases when the external interfaces or formats change.

Fourth, existing architectures commonly do not integrate user emotional states or real-time context into the generation of prompts for the generative AI model in a systematic way. Even when an emotion engine or similar component is present, its output is not consistently reflected as machine-processable constraints in the prompt sentence. This leads to a situation where the underlying computing system cannot fully exploit available signals to optimize the behavior of the generative model, resulting in suboptimal utilization of processor resources and network resources in providing contextually appropriate recommendations.

Accordingly, there is a need for an improved computer-implemented system and server architecture that: (i) integrates user attributes, preferences, and usage history into a coherent data structure; (ii) generates prompt sentences for a generative AI model that explicitly embed exclusion conditions derived from usage history; (iii) converts model outputs into structured management information including identifiers and availability information at external providing sources; and (iv) uses the structured information to automatically control content acquisition and history updates. Such an architecture can reduce redundant processing, decrease the number of unnecessary recommendations and network transactions, and improve the overall performance and resource efficiency of the computing system operating the recommendation and content acquisition workflow.

The specific processing by the specific processing unit 290 of the data processing device 12 in Application Example 1 is realized by the following means.

The present invention provides a server comprising a processor coupled to a data storage device and a communication interface, the processor being configured to obtain attribute information and preference information of a user from a user terminal, register the attribute information and the preference information in the data storage device, analyze the registered attribute information and the registered preference information, generate a prompt sentence for a generative AI model on the basis of an analysis result and, optionally, an emotional state of the user, cause the generative AI model to generate proposal information by using the prompt sentence as input, convert the proposal information into structured data including identification information and availability information for digital content provided by an external providing source, register the structured data in the data storage device as management information, access, via the communication interface, the external providing source on the basis of the management information, execute an automatic acquisition process for target content included in the proposal information, record usage history information in the data storage device on the basis of an acquisition status and a usage status of the target content, and identify already-acquired content or already-read content from the usage history information and include exclusion conditions corresponding to the already-acquired content or the already-read content in a subsequently generated prompt sentence so as to cause the generative AI model to generate proposal information excluding the already-acquired content or the already-read content. This enables the server to control the generative AI model using prompt sentences that encode system-level constraints derived from usage history, to reduce redundant recommendations and repeated processing of already-consumed content, to streamline automatic acquisition of digital content from external providing sources using structured management information, and to improve overall computational efficiency and resource utilization of the recommendation and content delivery workflow in the computer system.

The term “system” refers to a combination of hardware and software components including at least one processor, a data storage device, and a communication interface, configured to execute the operations described in the claims.

The term “processor” refers to one or more hardware processing units, such as a central processing unit or a graphics processing unit, that execute instructions to perform data processing, control logic, and communication operations of the system.

The term “data storage device” refers to one or more non-transitory computer-readable media, such as a magnetic disk, a solid-state memory, or an optical storage device, that store programs, parameters, and data including attribute information, preference information, proposal information, and usage history information.

The term “communication interface” refers to a hardware and software interface that enables the system to send and receive data over a wired or wireless communication network, including network interface controllers, communication protocols, and associated driver software.

The term “user” refers to a human individual or an organizational entity for whom the system generates proposal information and to whom digital content is provided.

The term “user terminal” refers to an information processing apparatus operated by the user, such as a personal computer, a mobile terminal, or a tablet device, that communicates with the server and presents information to the user.

The term “attribute information” refers to information representing characteristics of the user, including demographic attributes, profile attributes, or other descriptive parameters used by the system for analysis and proposal generation.

The term “preference information” refers to information representing likes, dislikes, interests, or desired categories of the user regarding digital content or services, which is used as a basis for generating proposal information.

The term “emotional state” refers to information representing an estimated or detected emotion of the user, such as satisfaction, boredom, excitement, or stress, obtained by an emotion detection mechanism and used to influence the generation of proposal information.

The term “generative AI model” refers to a machine learning model, such as a neural network-based model, that generates text or other output content in response to input data including prompt sentences, and that is used to generate proposal information in the system.

The term “prompt sentence” refers to a text string or equivalent structured input that is supplied to the generative AI model, the text string including attribute information, preference information, and constraint information to control the behavior of the generative AI model.

The term “proposal information” refers to information generated by the generative AI model, including candidate digital content items or services to be provided to the user, and optionally associated descriptive information.

The term “digital content” refers to information resources represented in electronic form, such as documents, media files, books, audio files, or other content items that can be delivered to and consumed by the user via the user terminal.

The term “external providing source” refers to an external information processing system or service that provides digital content or related resources, and that is accessible by the server through the communication interface.

The term “target content” refers to one or more digital content items selected from the proposal information as candidates for acquisition, delivery, or presentation to the user.

The term “automatic acquisition process” refers to a sequence of operations executed by the processor to obtain target content from the external providing source without requiring a manual operation by the user for each acquisition, including transmitting acquisition requests and receiving acquisition responses.

The term “communication application” refers to a software application or service configured to transmit notifications or messages from the server to the user terminal, such as a messaging application, a push notification service, or a similar communication mechanism.

The term “completion information” refers to information indicating that an automatic acquisition process for target content has been successfully completed or has reached a particular state, and that is transmitted from the server to the user terminal.

The term “usage history information” refers to information stored in the data storage device that represents acquisition status, consumption status, or interaction status of digital content with respect to the user, including timestamps and status values.

The term “acquisition status” refers to information indicating whether specific digital content has been requested, obtained, or failed to be obtained from an external providing source.

The term “usage status” refers to information indicating how and to what extent specific digital content has been consumed or interacted with by the user, such as a read status or a progress degree.

The term “already-acquired content” refers to digital content for which the acquisition status in the usage history information indicates that the content has been successfully obtained for the user.

The term “already-read content” refers to digital content for which the usage status in the usage history information indicates that the content has been consumed by the user at least to a predetermined threshold.

The term “constraint information” refers to information representing conditions or restrictions, including exclusion conditions, that are to be applied when generating proposal information by the generative AI model.

The term “exclusion conditions” refers to conditions specifying content that should not be proposed again, such as already-acquired content or already-read content, and that are encoded in the prompt sentence or otherwise used to control the generative AI model.

The term “structured data” refers to data expressed in a format with an explicit schema, such as a record, a table, or a key-value representation, in which fields such as content identifiers, availability information, and metadata are explicitly defined.

The term “identification information” refers to information that uniquely or specifically identifies digital content or an external providing source within the system or across systems, such as an identifier, a code, or a reference.

The term “availability information” refers to information indicating whether particular digital content is obtainable from an external providing source, and optionally indicating conditions such as format, region, or time of availability.

The term “management information” refers to structured data used by the server to manage automatic acquisition processes and usage history updates, including identification information, availability information, and links to usage history information.

In one embodiment, a server cooperates with one or more terminals operated by a user to implement a recommendation and content acquisition system that uses a generative AI model controlled by explicitly constructed prompt sentences. The server includes at least one processor, a memory, a non-transitory data storage device, and a communication interface connected to a communication network. The terminal includes a processor, a display, an input interface, a memory, and a communication interface.

The server uses a general-purpose computing platform, such as an x86-based or ARM-based machine running a server operating system. The server executes application software implemented, for example, using a high-level programming language and a web application framework. The server uses a relational database management system, such as a SQL-based database engine, as the data storage device. The server optionally uses a graphics processing unit for acceleration of a neural network model framework such as TENSORFLOW, which is used to implement the generative AI model.

The terminal uses a mobile operating system or a desktop operating system, and executes either a native application or a web browser. The terminal presents user interfaces for acquisition of attribute information and preference information, for display of proposal information, and for access to digital content. The terminal sends and receives data with the server using an application-layer protocol such as HTTP over a secure transport protocol.

The server stores structured data in the data storage device using a data schema that includes, for example, a user table, a preference table, a usage history table, a content table, and a recommendation management table. The user table stores attribute information, such as user identifiers and classification attributes. The preference table stores preference information associated with each user, such as preferred categories or creators. The usage history table stores usage history information, including acquisition status, usage status, timestamps, and content identifiers. The content table stores content metadata and mapping between internal identifiers and identifiers used by external providing sources. The recommendation management table stores structured data generated from proposal information, including identification information, availability information, and links to external providing sources.

The server obtains attribute information and preference information from the terminal and registers that information in the data storage device as structured records. The server analyzes the registered attribute information and preference information by applying a feature extraction process that converts categorical and textual data into numerical feature vectors. For example, the server uses word embedding tables or one-hot encodings to represent categories and identifiers, and uses normalization and encoding procedures to represent numeric attributes. The server may further derive compound features, such as co-occurrence counts or time-based preference weights, by executing aggregation queries on the data storage device.

The server optionally obtains information indicating an emotional state of the user from an emotion detection module. The emotion detection module may be implemented as a separate machine learning model that receives sensor data or interaction logs and outputs an estimated emotional label or score. The server stores this emotional state as an additional feature in an emotion history table or in association with the usage history table.

The server combines the attribute information, the preference information, and the usage history information into an internal data structure in memory. The internal data structure includes a list of content identifiers representing already-acquired content and already-read content, which the server determines by reading the usage history table and applying predefined status thresholds. The internal data structure also includes fields that describe the current context, such as time of day, device type, and recent interaction patterns.

The server generates a prompt sentence for the generative AI model by executing a deterministic text construction procedure. The server uses template strings and rule-based concatenation of text fragments, controlled by the internal data structure. For example, the server may generate a prompt sentence such as:

“User attributes: age in the 30s, prefers mystery and crime genres. User preferences: works by a specific author and similar authors. Already acquired or read: ‘Old Mystery Title 1’, ‘Old Mystery Title 2’. Please generate 5 recommended book titles and authors that match the preferences and are not in the already acquired or read list.”

In another example, the server may generate a prompt sentence such as:

“User interests: historical fiction and romance. User history: has finished reading ‘Summer in the City’ and ‘Autumn Letters’. Exclude these titles and propose 3 new digital books, providing only title and author for each.”

The server includes, in the prompt sentence, constraint information that encodes exclusion conditions for already-acquired or already-read content. The server performs this by retrieving identifiers and titles from the usage history table and inserting them into delimiters or specific text patterns in the prompt sentence. The server thereby enables the generative AI model to incorporate system-level constraints directly at the input stage.

The server implements the generative AI model using a neural network architecture, such as a transformer-type sequence-to-sequence model. The model includes an embedding layer, multiple attention-based layers, and an output projection layer connected to a vocabulary of tokens. The server loads model parameters stored on the data storage device into memory and, optionally, onto a graphics processing unit. The server tokenizes the prompt sentence using a tokenizer that maps characters or subwords to integer token identifiers. The server then feeds the token sequence through the neural network to generate an output token sequence. The server uses a decoding algorithm, such as beam search or top-k sampling, to generate a stable and diverse sequence of tokens representing proposal information.

The server trains the generative AI model in advance using a corpus of historical user interactions and content metadata. During training, the server defines an objective function such as a cross-entropy loss between predicted tokens and ground-truth tokens representing desirable suggestions. The server updates model weights using an optimization algorithm such as stochastic gradient descent or an adaptive method. The server may apply regularization techniques and data0 augmentation for robustness. Because the server integrates exclusion conditions and structured history-based constraints into the prompt sentences, the training process implicitly learns correlations between such constraints and the generated proposals, thereby improving model behavior under constrained prompts.

The server converts the output token sequence produced by the generative AI model into proposal information by decoding tokens into text segments and then applying a parsing routine that extracts candidate content items. For example, the server may use pattern-matching rules or delimiter detection to separate titles and creators. The server then converts the extracted elements into structured data records, each containing a content title field, a creator field, and optional supplementary fields.

The server associates the structured proposal information with records in the content table by executing matching algorithms. The server may perform approximate string matching or hash-based lookup to map generated titles to existing content identifiers. If the server finds matching records, the server adds identification information and availability information from the content table to each proposal record. If the server accesses external providing sources that maintain their own identifiers, the server stores mappings between internal identifiers and external identifiers in the content table or in a separate mapping table.

The server registers the structured and enriched proposal information as management information in the recommendation management table. The management information includes pointers to corresponding records in the usage history table and content table. By storing the proposal information in a structured form, the server enables efficient querying and re-use of recommendation data for subsequent operations.

The server controls automatic acquisition of target content from external providing sources based on the management information. The server composes acquisition requests containing external identifiers and user-related authorization data and transmits the requests through the communication interface. The server uses an application programming interface exposed by the external providing sources and adheres to the required protocols. Upon receiving acquisition responses that include acquisition status and access information, the server updates usage history information and management information accordingly.

The server records, in the usage history table, information indicating that certain content items have been successfully acquired, and may further update the usage history table when the terminal reports usage status such as progress or completion. The server controls future prompt sentence generation by using the updated usage history information as a basis to identify already-acquired content and already-read content and reflect such identification in new exclusion conditions.

The terminal receives notifications from the server, via a communication application or a push notification service, indicating completion of automatic acquisition of target content. The terminal then accesses a content retrieval endpoint indicated by the server and obtains the digital content data. The terminal stores the data locally and provides a user interface for rendering the digital content, such as displaying text pages or playing back audio. The terminal sends usage status reports to the server, including information such as the last accessed position in the content or the percentage of completion. This reporting allows the server to accurately maintain usage history information.

The server, by building prompt sentences that include structured constraint information derived from usage history, reduces the need for extensive post-processing of model outputs. The server therefore reduces the number of content items that must be filtered out after generation, reducing CPU cycles devoted to parsing and list comparison. The server also reduces the number of database queries needed to re-validate exclusion conditions after generation. As a result, the server can process a larger number of recommendation requests per unit time and lower the overall computational load.

The server improves data management by maintaining a clear separation and linkage among attribute information, preference information, usage history information, content metadata, and recommendation management information. The server uses schema-based tables and explicit foreign key relationships to ensure that each piece of data is accessible and modifiable in a structured manner. This design allows the server to perform targeted queries and updates, reducing I/O overhead and preventing redundant data storage.

The server also reduces communication load between the server and external providing sources. Because the server converts the generative AI model output into structured management information containing identifiers and availability information, the server can batch multiple acquisition operations based on a single recommendation or can pre-validate availability before initiating large data transfers. This reduces the number of failed acquisition attempts and associated network overhead.

From a technical perspective, the server does not merely automate a human selection task. The server uses non-conventional combinations of data structures, constraint-embedded prompt sentences, and generative AI model control to change how the computing system itself operates. The explicit encoding of exclusion conditions in the prompt sentences causes the internal neural network computations to be conditioned on system-level state, reducing the expected number of unsuitable outputs and thereby reducing the volume of downstream correction processing. This change in the order and content of operations leads to improved computational efficiency within the server.

In another embodiment, the server uses alternative neural network architectures for the generative AI model, such as recurrent networks or hybrid models that combine rule-based scoring and neural text generation. The server may use different tokenization strategies, such as character-level or byte-pair encoding, and may maintain multiple prompt generation templates for different content types. The basic principle of embedding system-derived constraint information into the prompt sentences and using structured management information for automatic acquisition and history management remains the same.

In yet another embodiment, the server uses a separate ranking module that rescored the structured proposal information output by the generative AI model. The server implements the ranking module as a machine learning model or a heuristic algorithm that uses features such as similarity between generated items and historical preferences, diversity metrics, and predicted completion probability. Even in this case, the server still uses prompt sentences with embedded exclusion conditions to reduce the set of candidate items before ranking, thereby further decreasing the computational cost of ranking.

In another variation, the server uses a plurality of external providing sources and maintains a routing table that specifies, for each content category, which external providing source should be queried. The server stores this routing information in the data storage device and uses it when generating management information from the proposal information. This configuration allows the server to dynamically distribute acquisition load and maintain technical efficiency across heterogeneous external platforms.

The described embodiments show that the server, by tightly coupling structured data management, prompt sentence generation, generative AI model control, and automatic acquisition workflows, achieves technical effects such as reduced redundant processing, improved processing speed, improved accuracy of recommendations with respect to user history, decreased communication overhead, and improved robustness against changes in external interfaces. The server thereby provides a concrete improvement in the functioning of the computer system that implements the recommendation and content acquisition functions.

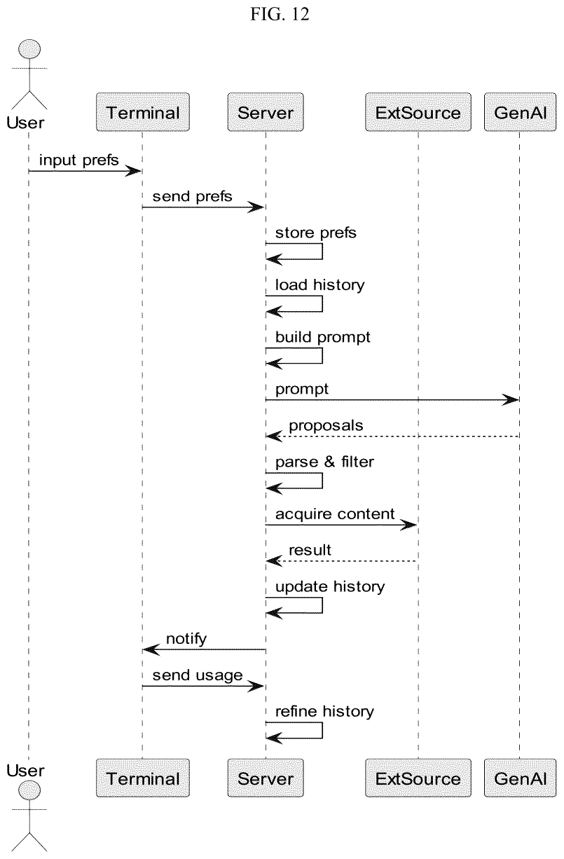

The following describes the processing flow using FIG. 12.
Step 1:

User operates the terminal to input attribute information and preference information.

User provides input such as age, general interest categories, and preferred content types using an input form displayed on the terminal.

Terminal receives the raw input data from UI components (text fields, check boxes, selection lists) and converts the input into an internal data structure.

Terminal generates, as output, a structured message including user identifier, attribute information, and preference information, and prepares this message as a request to be sent to the server.
Step 2:

Terminal transmits the structured message containing attribute information and preference information to the server.

Terminal uses a communication protocol to send the message as an HTTP request with a payload that encodes the structured data.

The input to this step is the internal data structure populated in Step 1, and the output is a network request containing the same data in a serialized form.
Step 3:

Server receives the network request from the terminal and parses the attribute information and preference information.

Server reads the request body, decodes the serialized representation, and extracts fields such as user identifier, attribute values, and preference values.

The input is the serialized message received over the network, and the output is a set of in-memory variables representing attribute information and preference information.
Step 4:

Server stores the parsed attribute information and preference information into a data storage device.

Server executes database insertion or update operations to register or modify records in a user table and a preference table.

The input is the in-memory representation of the user-related data, and the output is persistent records written to structured tables in the data storage device.
Step 5:

Server retrieves usage history information for the user from the data storage device.

Server executes database queries using the user identifier as a key and obtains records showing which content items have been acquired or read and their corresponding status values.

The input is the user identifier and query parameters, and the output is a collection of usage history records loaded into memory.
Step 6:

Server derives a list of already-acquired content and already-read content based on the usage history information.

Server applies a filtering operation, selecting records whose acquisition status or usage status meets predefined thresholds, and extracts content identifiers and titles from those records.

The input is the collection of usage history records, and the output is an exclusion list containing identifiers and titles of content that must not be proposed again.
Step 7:

Server constructs an internal context structure that combines attribute information, preference information, and the exclusion list.

Server creates a composite data object that includes fields for demographic attributes, encoded preferences, content identifiers to exclude, and optional contextual parameters such as time-of-day.

The input is the stored attribute information, stored preference information, and the exclusion list; the output is a unified context object held in server memory.
Step 8:

Server generates a prompt sentence for the generative AI model based on the internal context structure.

Server uses a template-based text generation procedure that inserts values from the context object into predefined sentence patterns, creating a natural-language instruction string that encodes user characteristics and exclusion conditions.

For example, server may output a prompt sentence such as: “User attributes: adult user with interest in mystery and crime genres. User preferences: works similar to a specific author. Already acquired or read: ‘Old Mystery Title 1’, ‘Old Mystery Title 2’. Please generate 5 recommended book titles and authors that match the preferences and are not in the already acquired or read list.”

The input is the internal context structure, and the output is a single prompt sentence string.
Step 9:

Server tokenizes the prompt sentence and prepares input data for the generative AI model.

Server passes the prompt sentence to a tokenizer component that maps characters or subword units to numerical token identifiers, producing a sequence of integers suitable for neural network processing.

The input is the prompt sentence string, and the output is a token sequence and associated attention masks or length parameters.
Step 10:

Server executes the generative AI model using the tokenized prompt as input.

Server feeds the token sequence into a neural network model, such as a transformer-based sequence model implemented in a neural network framework, and performs matrix multiplications, attention computations, and non-linear transformations layer by layer to generate output token scores.

The input is the tokenized prompt and current model parameters, and the output is a sequence of output tokens or token probability distributions representing generated proposal information.
Step 11:

Server decodes the output tokens from the generative AI model into proposal information in text form.

Server applies a decoding algorithm, such as beam search or sampling, to select a sequence of tokens from the output distributions, converts the tokens back into characters or words, and forms text lines containing candidate content titles and creators.

The input is the output token sequence or distributions from the model, and the output is a text string that lists proposed content items.
Step 12:

Server parses the proposal text into structured proposal records.

Server applies pattern-based parsing, splitting the proposal text into segments for each candidate item and further dividing each segment into fields such as title and creator.

The input is the raw text output produced in Step 11, and the output is a collection of structured proposal records, each containing fields for content title and creator.
Step 13:

Server correlates structured proposal records with content metadata stored in the data storage device.

Server executes matching operations, such as exact or approximate string comparison, between the proposed titles and the content table entries, and retrieves identifiers and availability information for matched items.

The input is the structured proposal records and the content metadata table, and the output is enriched proposal records that include internal content identifiers and availability attributes.
Step 14:

Server filters the enriched proposal records using the exclusion list derived from usage history.

Server compares content identifiers and titles from the enriched proposals with those in the exclusion list and removes any record that corresponds to already-acquired or already-read content.

The input is the enriched proposal records and the exclusion list, and the output is a filtered set of proposal records that satisfy the exclusion conditions.
Step 15:

Server stores the filtered proposal records as recommendation management information.

Server writes the filtered records into a recommendation management table, associating each record with a user identifier and timestamps, so that subsequent processes can access content identifiers and external source information without re-parsing the model output.

The input is the filtered proposal record set, and the output is persistent recommendation management records stored in the data storage device.
Step 16:

Server selects target content from the recommendation management information for automatic acquisition.

Server applies selection logic, such as choosing the highest-ranked items or items that meet price or availability constraints, and identifies one or more records as acquisition targets.

The input is the set of stored recommendation management records and selection criteria, and the output is a list of target content identifiers and corresponding external identifiers.
Step 17:

Server generates acquisition requests for the selected target content and sends them to external providing sources.

Server assembles request messages that include the external identifiers and authorization tokens and transmits the messages via the communication interface following the external provider's protocol.

The input is the list of target content identifiers and associated external metadata, and the output is a series of network requests addressed to the external providing sources.
Step 18:

Server receives responses from the external providing sources and determines acquisition status.

Server reads response messages, parses status codes, and extracts access information such as download URLs or content handles, then classifies each acquisition as successful or failed.

The input is the network responses from external providing sources, and the output is updated acquisition status for each target content item and associated access parameters.
Step 19:

Server updates usage history information based on acquisition status.

Server writes or updates records in the usage history table, setting fields such as acquisition status, acquisition time, and access information for each successfully acquired content item, and may log failure reasons for unsuccessful acquisitions.

The input is the acquisition status and access parameters from Step 18, and the output is an updated usage history table reflecting the new acquisition events.
Step 20:

Server generates and sends a notification to the terminal indicating completion of automatic acquisition.

Server constructs a notification message that includes content titles, creators, and information for accessing or opening the content on the terminal, then transmits the message using a communication application or push notification service.

The input is the updated usage history entry and access information, and the output is a notification payload delivered to the terminal.
Step 21:

Terminal receives the notification and prepares to access the acquired content.

Terminal processes the notification payload, displays information to the user, and, upon user interaction, extracts access information such as a link or identifier to retrieve the content from the external source or from a content server.

The input is the notification message from the server, and the output is an internal action on the terminal that triggers a content retrieval request.
Step 22:

Terminal retrieves the digital content based on the access information and stores it locally.

Terminal sends a retrieval request to the indicated endpoint, receives content data as a stream or file, and writes the data into local storage in an appropriate format.

The input is the access information obtained in Step 21, and the output is a locally stored digital content item ready for rendering.
Step 23:

Terminal renders the digital content and monitors usage status during consumption.

Terminal displays pages, plays audio, or otherwise presents the content to the user, and simultaneously logs information such as current position, elapsed time, or percentage of completion as the user interacts with the content.

The input is the locally stored content data and user interaction events, and the output is internal usage metrics maintained on the terminal.
Step 24:

Terminal transmits usage status reports to the server to update usage history information.

Terminal periodically or upon specific triggers sends messages that include identifiers of the consumed content, progress indicators, and timestamps to inform the server about the current usage status.

The input is the locally recorded usage metrics, and the output is a set of status report messages directed to the server.
Step 25:

Server receives usage status reports and refines usage history information.

Server parses the reports, verifies content identifiers, and updates the corresponding entries in the usage history table, marking items as read or completed when progress exceeds a threshold.

The input is the usage status report messages from the terminal, and the output is a refined and up-to-date usage history table.
Step 26:

Server uses the updated usage history information to adjust future prompt sentences for the generative AI model.

Server recomputes the exclusion list of already-acquired and already-read content and incorporates new exclusion conditions into subsequent prompt sentences, thereby preventing repetition and reducing unnecessary processing in later recommendation cycles.

The input is the refined usage history information, and the output is an updated context for the next prompt sentence generation that directly influences the subsequent execution of the generative AI model.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information recommendation systems typically rely on static user profiles and simple rule-based filtering to suggest items such as content, products, or services. These systems suffer from several technical limitations in how computing resources are utilized to generate and deliver recommendations.

First, such systems generally do not construct or update machine-readable prompt sentences that explicitly encode rich user preference constraints and exclusion conditions for input to a generative AI model. As a result, the interaction between the application logic and the generative AI model is often ad hoc and unstructured, leading to inefficient use of model computation, inconsistent output formats, and increased need for post-processing on the server.

Second, known systems frequently treat external information sources, such as catalog systems or reservation systems, as separate from the core recommendation computation. They do not tightly integrate availability information or processing status information from external information providing apparatuses into the recommendation pipeline. Consequently, the processor is required to perform additional filtering and reconciliation steps after recommendations have been generated, which increases processing latency and resource consumption, and may cause the system to present items that are not actually available to the user.

Third, many systems lack an automated feedback loop that updates internal preference weights and recommendation conditions based on the user's actual selection behavior and on reservation or acquisition outcomes. Without this structured, machine-level feedback, the processor cannot efficiently refine the parameters that govern prompt generation for the generative AI model. This leads to repeated recommendation of items that the user does not act upon, unnecessary calls to external systems, and suboptimal utilization of storage and communication resources.

Fourth, conventional architectures often do not manage “already processed” items-such as already read, already viewed, or already used items-in a way that is directly and systematically fed into the generative AI model input. Instead, such items are handled as simple flags or annotations at the user interface or application layer, requiring repeated checks and ad hoc exclusion logic. This fragmented handling increases complexity of the server-side code, burdens memory and processing cycles, and can result in inconsistent exclusion of already processed items across different recommendation requests.

Therefore, there is a need for a technical mechanism implemented on a server that: (i) acquires and stores user attribute, preference, and history data in a structured form; (ii) analyzes this data to generate machine-constructed prompt sentences with explicit exclusion and selection conditions for a generative AI model; (iii) tightly integrates external availability and process status information into both the recommendation generation and the subsequent reservation or acquisition processing; and (iv) automatically updates preference weights and management information for already processed items, thereby improving the efficiency, accuracy, and consistency of computer-implemented recommendation operations.

The specific processing by the specific processing unit 290 of the data processing device 12 in Example 2 is realized by the following means.

The present invention provides a server comprising a processor and an information storage device, the processor being configured to acquire user attribute information and preference information from a communication terminal, store the acquired user attribute information and preference information in the information storage device in association with past usage history of a user, analyze the stored user attribute information, preference information, and past usage history to generate a machine-readable prompt sentence including at least (i) a condition for excluding items already used or processed by the user, (ii) a condition for selecting items that match a preference of the user, and (iii) an output format required by a generative AI model, input the generated prompt sentence into the generative AI model that generates response information based on natural language processing, acquire candidate recommendation information output from the generative AI model in accordance with the prompt sentence, obtain external information regarding availability or provision status for the candidate recommendation information from an external information providing apparatus, generate final recommendation information by selecting or annotating the candidate recommendation information based on the external information, transmit a request for automatic reservation or acquisition of a recommendation item selected by the user to the external information providing apparatus, record a result of the reservation or acquisition in the information storage device and notify the communication terminal of the result via a communication application, manage, in the information storage device, items already used or processed by the user based on process status information acquired from the external information providing apparatus and update management information so that the items already used or processed are excluded from subsequent prompt sentence generation and selection of recommendation items by the generative AI model, and update preference weighting and recommendation conditions based on a selection history of the recommendation information by the user and execution results of the reservation or acquisition, and generate, as input to the generative AI model for subsequent executions, updated prompt sentences reflecting updated preference information and recommendation conditions. This enables the server to implement an integrated, computer-implemented recommendation pipeline in which prompt sentence generation, generative AI model interaction, external availability integration, and feedback-based preference updating are performed in a coordinated manner, thereby reducing processing redundancy, improving utilization of computational and communication resources, and enhancing the accuracy and responsiveness of recommendations provided to the user.

The term “processor” refers to one or more hardware processing units, such as a central processing unit or other computing circuitry, configured to execute instructions to perform the functions described herein.

The term “information storage device” refers to one or more hardware storage components, such as a memory device or non-volatile storage device, configured to store data including user information, history information, recommendation information, and management information.

The term “communication terminal” refers to an electronic device operated by a user, such as a mobile device, a personal computer, or another network-enabled device, that is capable of transmitting input information to and receiving output information from the server via a communication network.

The term “user attribute information” refers to information that characterizes a user, including but not limited to demographic information, language information, location information, or other profile information that identifies characteristics of the user.

The term “preference information” refers to information indicating likes, dislikes, interests, or tendencies of a user with respect to items to be recommended, including but not limited to preferred categories, genres, topics, or usage patterns.

The term “past usage history” refers to information representing records of items or services that a user has previously accessed, consumed, reserved, acquired, or otherwise processed, including associated timestamps, statuses, and contextual data.

The term “history information” refers to past usage history and related records stored over time, including chronological and statistical data describing the user's interactions with items, services, or recommendations.

The term “prompt sentence” refers to machine-readable text or structured natural language content that encodes conditions, constraints, and output requirements, and that is provided as input to a generative AI model to cause the model to generate recommendation information.

The term “generative AI model” refers to a software-implemented information processing model that generates output information, such as text or structured data, based on input information using natural language processing, machine learning, or other generative techniques.

The term “candidate recommendation information” refers to one or more items or item descriptions output by the generative AI model in response to a prompt sentence, prior to application of external availability information or additional filtering.

The term “final recommendation information” refers to recommendation information that has been derived from candidate recommendation information by applying external information, selection criteria, or annotation, and that is prepared for presentation to the user.

The term “external information providing apparatus” refers to an information processing system external to the server, such as a catalog system, reservation system, inventory system, or other service system, that provides information regarding availability, provision status, or processing status of items.

The term “external information” refers to information obtained from an external information providing apparatus, including but not limited to availability status, reservation status, inventory status, or processing state of items.

The term “availability or provision status” refers to a state indicating whether an item can be reserved, acquired, accessed, or otherwise provided to the user at a given time, as determined by the external information providing apparatus.

The term “reservation or acquisition process” refers to a sequence of operations performed by an external information providing apparatus in response to a request from the server, thereby reserving, allocating, or providing an item to the user.

The term “process status information” refers to information received from an external information providing apparatus that indicates a progress state or completion state of a reservation, acquisition, usage, return, or other operation related to an item.

The term “communication application” refers to a software application or service used to transmit messages or notifications to a communication terminal, including but not limited to messaging services, push notification services, or email services.

The term “management application” refers to a software component or system that manages information about items, including already read, already viewed, or already used items, and that provides management information to the processor for control of recommendation processing.

The term “already used or processed items” refers to items that have been determined, based on process status information or history information, to have been read, viewed, consumed, reserved, acquired, or otherwise completed by the user.

The term “management information” refers to data stored in the information storage device that indicates management states of items, including flags or attributes identifying items as already processed, excluded from recommendations, or subject to particular control conditions.

The term “preference weighting” refers to numerical or logical weight values or parameters associated with different user preferences, categories, or attributes, which are used by the processor to influence selection conditions in recommendation processing.

The term “recommendation conditions” refers to criteria, rules, or constraints applied by the processor to govern which items are to be selected or generated as recommendation targets, including inclusion conditions, exclusion conditions, and output format requirements.

The term “selection history” refers to records indicating which recommendation items were selected, acted upon, or ignored by the user, and any associated outcomes of subsequent reservation or acquisition processes.

The term “output format required by a generative AI model” refers to a specification, included in the prompt sentence, that defines how the generative AI model should structure its output, including but not limited to the number of items, field names, data schema, or representation style.

In one embodiment, a server implements the claimed system using one or more hardware processors, a main memory, a non-volatile storage device, and a network interface connected to a communication network. The server executes an operating system, such as a general-purpose server operating system, and an application stack including a web application framework, a database management system, and a client library for accessing a generative AI model. The server cooperates with at least one terminal, such as a smartphone, tablet, or personal computer, which executes a client application providing a graphical user interface for a user.

The server stores user attribute information, preference information, and history information in an information storage device structured as a relational database. For example, the server defines a user table, a preference table, a history table, and a recommendation table. The user table stores a user identifier, demographic attributes, and device-related metadata. The preference table stores category identifiers, genre codes, and numerical preference scores for each user. The history table stores item identifiers, status codes indicating read, viewed, or used state, timestamps, and links to external information providing apparatuses. The recommendation table stores candidate recommendation items, final recommendation items, and associated context, such as the prompt sentence used to generate each set of recommendations.

The server uses an application program to acquire user attribute information and preference information from the terminal. The user operates the terminal to input preferred genres, disliked categories, reading level, and other interest indications via form components of the client application. The terminal converts the input into structured data and transmits the data to the server over a secure communication channel. The server receives the data, validates field types and constraints, and stores the data in the information storage device. The server associates the stored preference information with the history information by linking them via user identifiers and item identifiers.

The server analyzes the stored user attribute information, preference information, and past usage history to compute internal preference weighting and exclusion lists. The server implements this analysis using deterministic algorithms and vector-based representations. For example, the server converts each genre or category into a dimension of a preference vector and updates the corresponding weight by applying a weighted moving average over counts of consumed items. The server generates an exclusion list by selecting item identifiers whose status codes in the history table indicate already read, already viewed, or already used. The server represents this exclusion list as a hash set in memory to enable constant-time lookup when constructing the prompt sentence and when post-processing outputs of the generative AI model.

The server generates a prompt sentence for the generative AI model using a prompt construction module. The server uses the preference vector, the exclusion list, and additional constraints, such as maximum number of items and output structure, as input to this module. The module combines fixed template strings and dynamic content through a deterministic template engine executed by the processor. For example, the server can generate a prompt sentence of the following form:

“You are a recommendation engine for reading materials.

The user prefers the following genres: mystery, historical fiction, and science fiction.

The user has already read the following titles: ‘Gone Girl,’ ‘The Hound of the Baskervilles,’ and ‘The Name of the Rose.’

Please recommend 10 books that match the user's preferred genres and that are likely not among the already read titles.

For each recommended book, output the title, author, primary genre, publication year, and a short summary under 80 words.

Do not include any book in the list of already read titles.

Return the recommendations in a consistent, clearly separable format.”

The server can generate alternative prompt sentences for different use cases. For example, the server can generate a prompt sentence emphasizing novelty and diversity:

“The user has frequently read mystery novels in the past six months and occasionally reads science fiction.

Based on this history, recommend 8 books that balance mystery elements with strong world-building and that are different in tone or setting from the user's recent reads.

Briefly explain, for each book, why it differs from the recent reading pattern while still matching the user's core preferences.”

The server provides the generated prompt sentence as input to a generative AI model via an application programming interface. The generative AI model is implemented as a neural network-based language model deployed on a remote computing platform. In one embodiment, the generative AI model is a transformer-based neural network including an embedding layer, multiple self-attention layers, feed-forward layers, and a final output layer that computes probability distributions over token sequences. The model parameters are stored as numerical weight matrices and bias vectors and are updated during a separate training phase.

The generative AI model is trained in advance on a large corpus of natural language text using a self-supervised learning method. The training procedure uses a loss function, such as a cross-entropy loss over predicted tokens versus target tokens, and an optimization algorithm, such as stochastic gradient descent or a variant thereof. During training, the model receives tokenized text, predicts subsequent tokens, and updates its weights by backpropagating the error signal. The model learns to represent semantic relationships, syntactic patterns, and contextual dependencies in a high-dimensional latent space.

At inference time, the server sends the prompt sentence as a sequence of tokens to the generative AI model. The model processes the token sequence through its transformer layers, computing attention weights between tokens and generating an internal contextual representation. The model predicts output tokens that form candidate recommendation information. The server controls generation parameters such as maximum output length, sampling temperature, and top-k or top-p sampling thresholds to adjust the diversity and determinism of the output. The server receives the generated text as candidate recommendation information.

The server parses the candidate recommendation information using a deterministic parser implemented in the application layer. The server identifies item boundaries, extracts fields such as title, author, and summary, and normalizes the data. For example, the server converts publication years into integers, trims whitespace, and applies language normalization rules. The server compares the extracted titles against the exclusion list using the hash set structure, and discards any items detected as already used or processed by the user. This explicit exclusion logic, performed at the server, ensures that items inadvertently included by the generative AI model despite exclusion instructions in the prompt sentence are removed before presentation.

The server obtains external information from an external information providing apparatus, such as a catalog system, inventory management system, or reservation system. The server transmits search queries containing item titles, authors, or standardized identifiers to the external apparatus. The external apparatus returns availability information and provision status, such as in-stock, reservable, checked out, or unavailable. The server merges this external information with the parsed candidate recommendation information. The server excludes items marked as unavailable, prioritizes items with immediate availability, and annotates items with availability indicators and expected wait times. The server generates final recommendation information by applying a selection algorithm that combines internal preference weighting with external availability indicators. For example, the server computes a composite score for each candidate item by applying a formula that weights user preference match, novelty score derived from history analysis, and availability score derived from the external apparatus. The server sorts the items according to the composite score and selects a subset as final recommendation information. The server stores the final recommendation information and its generation context in the recommendation table for future analysis.

The server transmits the final recommendation information to the terminal. The terminal receives the data and renders a list of recommended items. The user operates the terminal to select one or more items for reservation or acquisition. The terminal transmits the selected item identifiers and the user identifier to the server. The server then sends a reservation or acquisition request to the external information providing apparatus. The external apparatus performs reservation or allocation operations on its own hardware resources, such as database updates and inventory locking, and returns a process status response to the server.

The server records the process status response in the information storage device, linking each reservation or acquisition to the corresponding user, item, and recommendation context. The server also uses a communication application interface to notify the terminal of completion or failure. For instance, the server can send a text message containing the reserved title, reservation identifier, and pickup instructions through a push notification mechanism or a messaging service.

The server continuously manages items already used or processed by the user. Based on process status information from the external apparatus and confirmations from the terminal, the server updates the history table to set status codes indicating read, viewed, returned, or completed. The server includes these items in the exclusion list for subsequent prompt sentence generation and recommendation selection. This closed feedback loop eliminates redundant recommendations and reduces server-side processing because items known to be ineligible are filtered at the data structure level before the generative AI model is invoked.

The server updates preference weighting and recommendation conditions based on the user's selection history and reservation or acquisition outcomes. The server analyzes, for each recommendation session, which items were selected, which items were ignored, and which reservations or acquisitions were successfully completed. The server modifies the preference vector by increasing weights for genres or attributes associated with frequently selected and successfully completed items and decreasing weights for attributes associated with unselected items. The server can implement this as an online learning mechanism, such as an exponential moving average or a multi-armed bandit-type update rule, that adjusts numerical weights stored in the preference table. The server incorporates the updated preference weights and exclusion lists into subsequent prompt sentence generation, thereby making the interaction between the server and the generative AI model more structured and efficient. Because the prompt sentence now encodes refined constraints and updated output requirements, the generative AI model receives a more informative and narrowly defined input. This reduces the need for extensive post-processing, lowers the volume of irrelevant candidate outputs, and consequently reduces computational load and network traffic.

The described configuration improves computer technology in several ways. The server uses explicit data structures, such as preference vectors and exclusion hash sets, in combination with prompt sentences tailored for the generative AI model, to structurally constrain the model's output domain. This yields a measurable reduction in the number of candidate items that must be processed and filtered, improving processing speed and reducing memory usage. The tight integration of external availability information into the recommendation pipeline further avoids unnecessary recommendations of unavailable items, decreasing repeated network calls and reducing communication load between the server and the external apparatus.

Moreover, the use of a transformer-based generative AI model is not merely a substitution for human judgment. The server exploits the model's high-dimensional contextual representation to generate recommendations under complex constraints encoded in the prompt sentence, and the server's deterministic algorithms systematically correct and refine the model's outputs. The server's feedback-driven weight updating mechanism operates at a granularity and scale that are impractical for manual human operation, and it continuously tunes recommendation parameters embodied in machine-readable data structures. This combination yields enhanced precision of content selection, lower error rates in availability and duplication, and improved responsiveness of the overall system. In alternative embodiments, the server can employ different database technologies, such as a key-value store or a document-oriented database, while preserving the logical structure of user attributes, preferences, histories, and recommendations. The server can also employ different neural network architectures for the generative AI model, such as recurrent neural networks or hybrid encoder-decoder models, as long as the model can accept a prompt sentence and generate text-based recommendation candidates. The learning method can incorporate additional techniques, such as regularization, curriculum learning, or data augmentation applied to training data, to improve generalization and robustness of the model.

In another embodiment, the server can operate multiple generative AI models, each specialized for a different domain of items, and select or weight the models according to user preferences and history. The server can also adjust the internal parsing and normalization algorithms to support different languages or content types. These variations retain the core concept of using structured prompt sentences, exclusion management, external availability integration, and feedback-based preference updating to improve the technical performance of a computer-implemented recommendation system.

Through these embodiments, the server configures the interaction between stored data structures, prompt sentence construction, generative AI model inference, external apparatus integration, and feedback analysis in a specific, non-conventional manner that yields tangible improvements in computational efficiency, accuracy of recommended items, and resource usage within the computing environment.

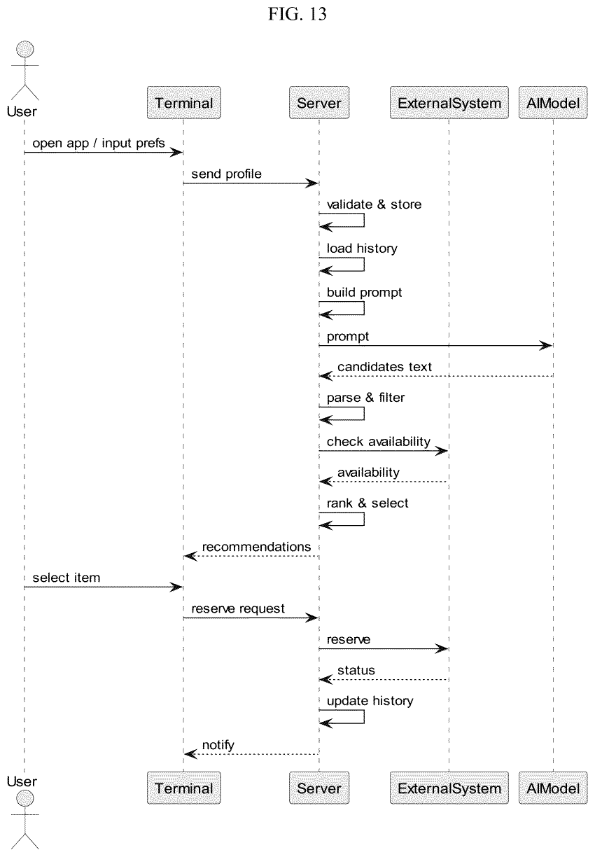

The following describes the processing flow using FIG. 13.
Step 1:

The user operates the terminal to launch a client application and open a profile or preference input screen. The terminal displays input fields for user attributes (such as age range, language, region) and preference information (such as preferred genres, disliked genres, reading level, and typical consumption frequency). The user enters values into these fields and confirms the input. The terminal converts the entered values into a structured data object, for example a set of key-value pairs, and attaches a user identifier if available. The terminal sends this structured data to the server via a network request.

Input: Raw keystrokes and selections from the user.

Output: A structured user profile and preference data object transmitted to the server.
Step 2:

The server receives the profile and preference data object from the terminal through a network interface. The server validates the data by checking required fields, allowed value ranges, and data types using a validation module. The server performs data cleaning operations such as trimming whitespace, normalizing genre labels to internal codes, and converting textual numeric input into numerical types. The server then writes the validated and normalized data into the information storage device, associating it with a unique user identifier.

Input: Structured user profile and preference data object from the terminal.

Output: Validated and normalized user attribute and preference records stored in the database.
Step 3:

The server retrieves existing history information for the same user from the information storage device. The server loads records from a history table, including item identifiers, status codes (read, viewed, completed, returned), timestamps, and associated genres. The server aggregates this history to compute frequency counts per genre, recency scores for items, and a list of items marked as already used or processed. The server converts these aggregates into a preference vector and an exclusion set stored in working memory.

Input: Historical usage records for the user from the database.

Output: A numerical preference vector and an in-memory exclusion set of already processed item identifiers.
Step 4:

The server analyzes the user attribute information, preference information, and the computed preference vector to derive recommendation conditions. The server calculates weight values for each genre based on a combination of declared preferences and observed consumption frequency, for example by applying a weighted average function. The server determines constraints such as desired number of recommendations, diversity level between genres, and recency thresholds for items. The server stores these conditions in a recommendation context object.

Input: User attributes, stored preference records, preference vector, and exclusion set.

Output: A recommendation context object containing genre weights, exclusion rules, output size, and diversity constraints.
Step 5:

The server constructs a prompt sentence for the generative AI model by passing the recommendation context object to a prompt construction module. The prompt construction module selects a text template and fills in placeholders with concrete values such as preferred genres, list of already read titles, and required output fields. The server concatenates the template segments in a deterministic order and ensures that the resulting prompt sentence explicitly encodes constraints, such as “do not include” conditions and required information fields.

Input: Recommendation context object, including genre weights, exclusion set, and output requirements.

Output: A fully constructed prompt sentence in natural language ready for input to the generative AI model.
Step 6:

The server sends the prompt sentence to the generative AI model via an application programming interface. The server tokenizes the prompt sentence if required by the client library, sets generation parameters such as maximum token length, temperature, and sampling method, and transmits the request. The generative AI model processes the token sequence using its internal neural network architecture, computing attention scores and context-aware token probabilities, and generates an output text containing candidate recommendations. The server receives this output text as a response.

Input: Prompt sentence and generation parameters.

Output: Raw text generated by the generative AI model containing candidate recommendation descriptions.

### Step 7:

The server parses the raw generated text to extract structured candidate recommendation information. The server uses parsing rules or regular expressions to detect item boundaries, titles, authors, genres, publication years, and summaries. The server normalizes field values, for example by converting year strings to integers, mapping genre names to internal codes, and removing extraneous punctuation. The server discards malformed entries that lack required fields. The server stores the extracted candidate items temporarily in a candidate list in memory.

Input: Raw generated text from the generative AI model.

Output: A structured candidate list of recommendation items with normalized fields.
Step 8:

The server filters the candidate list using the exclusion set created from the user's history. The server compares each candidate item's identifier or title against the exclusion set using hash-based lookup. If a candidate item matches an already processed item, the server removes the candidate from the list. The server may also apply threshold-based checks on similarity measures to avoid near-duplicates. The filtered list becomes a refined candidate list.

Input: Structured candidate list and exclusion set of already processed items.

Output: A refined candidate list that excludes items already read, viewed, or used by the user.
Step 9:

The server queries an external information providing apparatus to obtain availability or provision status for each item in the refined candidate list. The server constructs one or more query messages containing item titles, authors, or standardized identifiers, and sends them over a network interface. The external apparatus responds with availability codes, such as available, reservable, checked out, or out of stock, and may provide additional metadata such as branch location and expected availability dates. The server associates this external information with each corresponding candidate item.

Input: Refined candidate list of items requiring availability checks.

Output: Refined candidate list annotated with availability and provision status information from the external apparatus.
Step 10:

The server computes a composite ranking score for each annotated candidate item. The server combines internal preference weights, novelty scores derived from history analysis, and availability scores derived from external status codes using a predetermined formula or weighted sum. The server then sorts the annotated candidate list in descending order of composite score. The highest-scoring items are selected as final recommendation information, up to the number specified in the recommendation context. The server writes the final recommendation information and associated scores into the recommendation table in the information storage device.

Input: Annotated candidate list with preference weights, novelty measures, and availability information.

Output: Final recommendation information list ordered by composite score and stored persistently.
Step 11:

The server sends the final recommendation information to the terminal. The server formats the information as a structured response, including item titles, authors, genres, summaries, and availability indicators. The terminal receives the response and parses the structure to populate user interface components. The terminal displays a recommendation list to the user, showing key attributes and emphasizing availability status. The user inspects the displayed items and decides which item or items to select for reservation or acquisition.

Input: Final recommendation information list stored by the server.

Output: Rendered recommendation list on the terminal, visible to the user for selection.
Step 12:

The user operates the terminal to select one or more recommended items and initiates a reservation or acquisition action, for example by tapping a “reserve” button. The terminal collects identifiers of the selected items and the user identifier, and packages them into a reservation request. The terminal sends this request to the server using a secure communication channel.

Input: User's selection actions on the recommendation list displayed on the terminal.

Output: A reservation or acquisition request message transmitted from the terminal to the server.
Step 13:

The server receives the reservation or acquisition request and verifies that the requested items match entries in the stored final recommendation information. The server checks availability status and confirms that the items are still reservable or acquirable. The server then constructs and transmits a reservation or acquisition command to the external information providing apparatus. The external apparatus executes operations such as updating inventory records and creating reservation entries, and returns a process status response containing identifiers and outcome codes. The server records these outcomes in the history and reservation-related tables in the information storage device.

Input: Reservation or acquisition request from the terminal and final recommendation records.

Output: Updated reservation and history records reflecting the outcome of the reservation or acquisition process.

### Step 14:

The server generates a notification message summarizing the reservation or acquisition result, including item title, reservation identifier, status, and any relevant instructions. The server sends this message to the communication application associated with the terminal, such as a push notification or messenger service. The terminal receives the notification and displays it on-screen. The user views the message and confirms that the reservation or acquisition has been completed or failed.

Input: Process status response from the external information providing apparatus and stored item context.

Output: A user-visible notification on the terminal conveying the reservation or acquisition result.
Step 15:

The server updates the user's history and management information based on the process status information received from the external apparatus. The server sets or updates status codes for items as reserved, borrowed, returned, or completed, and updates timestamps accordingly. The server recomputes the exclusion set by adding newly completed or processed items. The server also updates numerical preference weights and recommendation conditions by analyzing which recommended items were selected and successfully reserved or acquired. These updates are stored in the information storage device and are used as input to subsequent executions of Steps 3 through 5.

Input: Process status information from the external apparatus and the user's existing history and preference records.

Output: Updated history records, exclusion set, and preference weighting that influence future prompt sentences and recommendation computations.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information recommendation systems typically rely on static user profiles and simple collaborative filtering or content-based filtering algorithms executed on generic computing hardware. Such systems suffer from several technical shortcomings in terms of how a computer collects, represents, and processes user-related data to generate proposals.

First, conventional systems generally treat user feedback as coarse-grained numeric ratings or binary “consumed/not consumed” flags stored in a database. These systems do not integrate fine-grained emotion information into the internal data structures and processing pipelines of the computer. As a result, the processor cannot distinguish between content that was merely consumed and content that evoked a strongly positive or negative reaction, and the recommendation logic cannot be optimized around such distinctions. This leads to inefficient use of storage and compute resources, because the same types of items may be repeatedly proposed and evaluated without leveraging prior emotional reactions.

Second, many existing systems generate recommendations directly from the stored data using fixed algorithms, and when they do incorporate a generative AI model, they typically provide only minimal context to the model. In these systems, the processor constructs prompts in an ad-hoc manner without a structured process for encoding exclusion rules, prioritization rules, or emotion-based constraints. The generative AI model therefore receives under-specified or noisy inputs, which forces the model to spend more computation resolving ambiguities and tends to produce proposals that require extensive post-filtering on the server side. This increases processing latency and results in redundant database queries and network calls.

Third, conventional systems that interface with external information sources (such as content platforms or catalog services) commonly separate the recommendation stage from the reservation or acquisition stage. Recommendations are often presented to the user as a list, and any reservation or acquisition is triggered manually by the user. This design requires repeated user-server interaction, generates additional network requests, and results in fragmented state between recommendation data structures and reservation data structures. The computer must then run duplicate checks and synchronization processes, increasing CPU load and memory usage.

Fourth, existing systems do not systematically integrate external management applications that track already-consumed items into the core recommendation pipeline. Even when such applications exist, they are frequently accessed only as an auxiliary log. As a consequence, already-consumed items or duplicate items can be proposed again by the recommendation engine, causing unnecessary database reads, unnecessary external API calls, and additional user interactions to dismiss redundant proposals.

Fifth, in typical architectures, the representation of user behavior history, evaluation information, and emotion information is not directly leveraged to dynamically alter the structure of prompts sent to a generative AI model. The prompts remain largely static templates, and any reconfiguration of output types, formats, or priorities is performed by downstream rule-based filters on the server. This architecture forces the processor to perform multiple passes over recommendation results and to maintain complex filtering logic, leading to higher CPU utilization and increased memory footprint, and making the system difficult to scale and maintain.

Accordingly, there is a need for a technical mechanism by which a processor can (i) coherently collect and normalize attribute information, preference information, behavioral history information, evaluation information, and emotion information into machine-processable structures; (ii) algorithmically construct prompt sentences that explicitly encode exclusion conditions and prioritization conditions before invocation of a generative AI model; (iii) automatically coordinate with external information sources to perform acquisition reservation and state registration; and (iv) tightly integrate management application data (including already-consumed information) into the recommendation loop. By addressing these issues at the level of data structures, prompt construction logic, and API orchestration, the computer system can reduce redundant processing, lower network overhead, and improve the relevance and efficiency of information proposals in a way that constitutes an improvement in computer-implemented recommendation technology itself.

The specific processing by the specific processing unit 290 of the data processing device 12 in Application Example 2 is realized by the following means.

The present invention provides a server comprising a processor and a storage medium, the processor being configured to receive and register, in the storage medium, user attribute information and preference information from a user terminal, to collect and store, in the storage medium, behavioral history information, evaluation information, and emotion information associated with the user, to analyze the behavioral history information and the emotion information to extract, for each user, information items representing positive reactions and information items representing negative reactions, to construct, based on the attribute information, the preference information, the behavioral history information, the evaluation information, and the emotion information, a structured prompt sentence for a generative AI model including explicit instruction content that designates information items already obtained by the user and information items representing negative reactions as exclusion targets and that designates information items similar to the information items representing positive reactions as prioritized targets, to input the prompt sentence into the generative AI model and obtain proposed information from the generative AI model, to generate a recommended information set by excluding, from the proposed information, already-obtained information items and duplicate information items based on the behavioral history information and management data stored in the storage medium, to execute, for each information item included in the recommended information set, an automatic acquisition reservation process through a communication interface of an external information source and register a reservation state in the storage medium, to generate, based on the reservation state, a notification message and transmit the notification message to the user terminal via a communication application, and to receive, from the user terminal, evaluation input or explicit emotion input, register the received input as emotion information in the storage medium, and update subsequent construction of the prompt sentence based on the registered emotion information so as to adjust proposed information in later executions. This enables the computer system to internally encode comprehensive user-specific state, including consumption status and emotion-based preferences, directly into the prompt sentences supplied to the generative AI model, to offload a portion of the recommendation reasoning to the generative AI model under precise exclusion and prioritization constraints, to avoid redundant proposal of already-consumed or disfavored information, to reduce unnecessary database processing and external API calls through automatic reservation and unified state registration, and thereby to improve the efficiency, scalability, and technical performance of computer-implemented information recommendation and acquisition operations.

The term “processor” refers to a hardware computation unit, such as a central processing unit or an execution core, that executes instructions to perform data acquisition, analysis, prompt construction, communication, and control operations in the system.

The term “storage medium” refers to any non-transitory computer-readable medium, such as a semiconductor memory, magnetic storage, or optical storage, configured to store user-related data, management data, reservation data, and program instructions.

The term “user attribute information” refers to data describing static or slowly changing characteristics of a user, such as demographic characteristics, category preferences, or general interest profiles, that are used as inputs to recommendation processing.

The term “preference information” refers to data indicating content categories, topics, or other selection criteria that a user favors, such as preferred genres, themes, or creators, which influence ranking and selection of information items.

The term “behavioral history information” refers to data records that log user actions related to information items, including consumption events, start and completion events, access counts, and timestamps, which are used to infer consumption status and usage patterns.

The term “evaluation information” refers to data representing explicit user assessments of information items, such as numerical ratings, textual reviews, or categorical feedback, which are used to derive the user's degree of satisfaction with consumed items.

The term “emotion information” refers to data representing the emotional state or reaction of a user in association with an information item, such as labels or scores for joy, sadness, fear, or other affective states, obtained from explicit user input or from an emotion recognition process.

The term “positive user reactions” refers to emotional or evaluative responses of the user that indicate preference or satisfaction with an information item, such as high ratings or emotion information dominated by positive affect.

The term “negative user reactions” refers to emotional or evaluative responses of the user that indicate dislike, discomfort, or dissatisfaction with an information item, such as low ratings or emotion information dominated by negative affect.

The term “information item” refers to an identifiable unit of content or data, such as a document, a media work, a record, or a digital resource, that can be proposed, reserved, acquired, and consumed by the user.

The term “prompt sentence” refers to a machine-interpretable natural-language text, optionally structured in multiple sentences or paragraphs, that encodes conditions, constraints, and context and is provided as input to a generative AI model to obtain proposed information.

The term “generative AI model” refers to a machine-learning model that generates output data, such as textual proposals of information items, in response to an input prompt sentence, by performing probabilistic or neural network-based inference.

The term “proposed information” refers to information items or descriptions of information items output from the generative AI model in response to a prompt sentence, prior to filtering or post-processing by the processor.

The term “recommended information set” refers to a filtered collection of information items derived from the proposed information by excluding already-obtained items, duplicate items, and items that do not satisfy system constraints, and which is intended to be suggested to the user.

The term “already-obtained information items” refers to information items that the system determines, based on behavioral history information or management data, have been acquired, consumed, or completed by the user.

The term “duplicate information items” refers to information items in the proposed information that represent the same or substantially the same content as other items within the same proposal or within the user's existing data, as determined by identifiers or similarity criteria.

The term “external information source” refers to an external system or service that maintains a catalog, repository, or platform for information items and that can receive reservation or acquisition requests via a communication interface.

The term “communication interface of an external information source” refers to a programmatic access mechanism, such as an application programming interface or a network protocol endpoint, provided by an external information source to accept queries, reservations, and state updates.

The term “acquisition reservation process” refers to a series of operations in which the processor sends a request to an external information source through its communication interface to reserve or pre-register access to an information item for a specific user.

The term “reservation state” refers to status data indicating a current reservation condition of an information item at an external information source, including values such as reserved, pending, waitlisted, available, or completed.

The term “communication application” refers to an application or service that delivers messages, notifications, or alerts over a network to a user terminal, such as a messaging system, push-notification service, or communication client.

The term “user terminal” refers to an endpoint device operated by a user, such as a personal computer, a mobile terminal, or another network-connected computing apparatus, configured to exchange data with the server and present information to the user.

The term “management application” refers to a software system or service that stores and manages records of information items associated with a user, including already-consumed information, and provides data to the server for use in recommendation processing.

The term “management application storage medium” refers to a storage resource associated with the management application that holds records of information items, including flags or fields indicating that the items are already consumed.

The term “already-consumed information” refers to information items that the system registers, in the management application storage medium or in the storage medium, as having been fully acquired, read, watched, or otherwise completed by the user.

The term “exclusion targets” refers to information items or categories that are explicitly designated in a prompt sentence or internal logic as not to be proposed by the generative AI model or as to be removed by post-processing.

The term “prioritized targets” refers to information items or categories that are explicitly designated in a prompt sentence or internal logic as having higher selection priority or recommendation weight relative to other items.

The term “reaction tendencies” refers to statistical or rule-based patterns derived from behavioral history information, evaluation information, and emotion information that indicate how users with particular attributes tend to react to different types of information items.

The term “output format of the prompt sentence” refers to constraints and specifications encoded within or alongside a prompt sentence that instruct the generative AI model regarding the structure, schema, or representation of its response.

In one embodiment, a server implements the claimed system using a general-purpose computing device including at least one processor, a main memory, a non-transitory storage device, and a network interface. The server executes an operating system such as a general-purpose server operating system and an application stack including a web application framework, a database management system, and an application program for recommendation processing. The server communicates with one or more terminals operated by users via a communication network.

The terminal is a computing apparatus such as a smartphone, tablet, or personal computer that includes a processor, a display device, an input device, optionally a camera and microphone, a local memory, and a communication module. The terminal executes a client application or web browser that provides user interfaces for registering user attribute information and preference information, providing evaluation information and emotion information, and receiving recommended information and notification messages from the server.

The user operates the terminal to input user attribute information, such as demographic characteristics and interest categories, and preference information, such as preferred genres of content and favored types of information items. The terminal converts the user's input into structured data objects and transmits the structured data objects to the server through the network interface using a predefined application protocol. The terminal also displays recommendation results and reservation states sent from the server and accepts user feedback, such as ratings or explicit emotion labels.

The server stores user attribute information, preference information, behavioral history information, evaluation information, emotion information, and reservation information in a storage medium implemented by a database management system such as a relational database. The database management system manages multiple tables or collections, for example: a user profile table storing user identifier fields and attribute fields, a preference table storing content category preferences, a behavioral history table storing records of content consumption events, an evaluation table storing rating values, an emotion table storing emotion labels and scores, a recommended information table storing proposed information items, and a reservation table storing reservation states received from external information sources.

The server uses a data model in which each information item is represented by an identifier, a title field, one or more category fields, optional creator fields, and a set of feature fields indicating metadata such as length, language, or difficulty level. The behavioral history table associates information item identifiers with user identifiers, consumption status fields, and timestamps. The emotion table associates information item identifiers with user identifiers and emotion features, such as continuous scores for joy, sadness, fear, and disgust. In some embodiments, the emotion features are obtained from an emotion recognition model executing on the terminal or the server using sensor data from a camera or microphone. In other embodiments, the emotion features are explicitly input by the user as textual descriptions or category selections.

The server constructs a feature vector for each user by aggregating the stored data. The feature vector includes, for example, counts of information items consumed per category, average rating values per category, average emotion scores per category, and binary flags indicating whether particular categories are to be avoided or prioritized. The server updates these feature vectors whenever new behavioral history information, evaluation information, or emotion information is stored. The server also maintains an index of already-consumed information items and negative-reaction items for each user, which is used to generate exclusion lists.

The server interfaces with a generative AI model implemented as a neural network-based text generation model that receives a prompt sentence and outputs a sequence of tokens representing proposed information. In one embodiment, the generative AI model is a transformer-based language model trained on large-scale text data and further adapted to the domain of content recommendation by fine-tuning on training pairs of prompt sentences and expected lists of information items. The internal parameters of the model include multiple layers of self-attention modules, feed-forward networks, and embedding matrices. The model is trained using supervised learning with a loss function such as cross-entropy between generated token sequences and target token sequences, and its parameters are updated by a gradient-based optimization algorithm.

The server does not treat the generative AI model as a black box; instead, the server explicitly controls the structure and contents of the prompt sentence to direct the internal inference process of the model. The server selects feature subsets and constructs a natural-language description that encodes both positive and negative constraints. For example, the server uses template structures such as:

“The user is a 35-year-old reader who prefers mystery and fantasy books. The user has already read and enjoyed the following books: ‘Mystery Title A’ by Author X and ‘Fantasy Title B’ by Author Y. The user did not enjoy ‘Horror Title C’ by Author Z. Please propose ten new books that the user has not read yet, focusing on mystery and fantasy with a positive and exciting mood, and avoid books similar to ‘Horror Title C’. Provide the results as a list of titles, authors, and short reasons.”

In another example, the server generates a prompt sentence for audiovisual content, such as: “The user is a 28-year-old viewer who prefers action and science fiction movies. The viewing history shows: ‘Action Movie A’ (high rating, joy), ‘Sci-Fi Movie B’ (moderate rating, interest), and ‘Dark Thriller C’ (low rating, fear and sadness). The user wants to avoid dark or depressing content. Please propose eight action or science fiction movies that the user has not watched yet, avoiding dark thrillers, and list the titles, genres, and reasons.”

The server encodes explicit exclusion targets and prioritized targets into the prompt sentence. For example, the server appends instruction segments such as “Do not include any of the following titles, which the user has already consumed: . . . ” and “Prioritize items similar to the following positively received titles: . . . ” The server further instructs the generative AI model about output format by including segments such as “Return the result as a numbered list of items, each item including a title, a category, and one sentence explaining why it is suitable.”

The server generates the prompt sentence by assembling textual segments from a library of templates combined with user-specific data retrieved from the database. The server uses conditional logic to select different templates depending on the user's reaction tendencies and the amount of available historical data. For example, when the server detects that the user has strong negative emotions for a particular category, the server inserts a sentence such as “Avoid horror content because the user often experiences strong fear with horror items.” This non-conventional prompt construction process causes the generative AI model to perform constrained generation directly, which reduces the need for complex post-filtering and lowers computational load on the server.

The server transmits the constructed prompt sentence to the generative AI model through a model interface implemented by an application programming interface. The server sets inference parameters such as maximum output length, temperature, and top-k or top-p sampling thresholds to control diversity and determinism of the output. The server receives the output tokens from the model, decodes the tokens into a text sequence, and parses the text sequence to extract proposed information items. The server may use natural-language parsing rules or simple pattern matching, depending on the chosen output format.

The server then performs a post-filtering process using the internal index of already-consumed information items and the management application data. The server compares each proposed item against the stored identifiers and title strings in the behavioral history table and in the management application storage medium. When the server detects a duplicate or already-consumed item, the server discards the item and optionally requests the generative AI model to generate additional items by appending updated instructions to a new prompt sentence. By performing exclusion both within the prompt sentence and during post-filtering, the system reduces the likelihood that duplicate items are transmitted to the terminal and thereby reduces redundant user interactions.

The server interacts with external information sources via communication interfaces provided as web-based application programming interfaces. The server maps proposed information items to catalog entries at the external information sources by performing lookup queries using titles, categories, and creator names. The server identifies matching entries and constructs reservation requests that include user identifiers, selected item identifiers, and reservation parameters. The server transmits the reservation requests to the external information sources and receives reservation states, such as reserved, queued, or unavailable. The server stores the reservation states in the reservation table with timestamps.

The server constructs notification messages based on the reservation states and recommended information sets. For example, the server generates a message like “The book ‘Mystery Title A’ has been reserved and will be available for pickup at Library X by [date]” or “The movie ‘Action Movie A’ has been added to your watchlist and is now available for streaming.” The server transmits the notification messages to the terminal via a communication application that uses push messaging or chat protocols. The terminal receives and displays the notifications, allowing the user to access or retrieve the reserved items.

The server receives evaluation information and explicit emotion information from the terminal after the user has consumed recommended items. The terminal presents interfaces for the user to rate items and to specify emotions, for example, “very enjoyable,” “boring,” or “too scary.” The terminal transmits the user's input to the server. The server writes the new evaluation information and emotion information to the respective tables and updates the feature vectors and reaction tendencies for the user. The server then regenerates new prompt sentences that take into account the updated reaction tendencies, thus continuously adapting the recommendation behavior.

The described configuration yields technical effects that go beyond mere automation of human decision-making. By encoding detailed user-specific state, including positive and negative emotion information, directly into prompt sentences for a generative AI model, the server offloads a portion of constrained optimization to the model while maintaining precise control over inclusion and exclusion conditions. This reduces the number of candidate items that must be processed and filtered by conventional algorithms. The result is a decrease in the number of database queries and join operations executed per recommendation cycle, which improves processing speed and reduces server resource consumption.

Furthermore, because the server systematically collects and aggregates emotion information and behavioral history information into structured feature vectors, the server can compute reaction tendencies and adjust prompt sentence templates without retraining the generative AI model. This separation of model parameters from prompt construction logic enables dynamic adaptation to individual users while avoiding high computational cost associated with frequent model retraining. As a consequence, the system improves scalability when serving a large number of users.

The server's coordinated interaction with external information sources and management applications also contributes to technical improvements. Automatic reservation processes and integrated registration of reservation states into a unified storage medium reduce the need for separate synchronization processes and manual user actions. By integrating already-consumed information from a management application into both the prompt sentence and the filtering logic, the server prevents duplicate reservations and suppresses unnecessary network traffic to external services. This reduction in extraneous network communications lowers latency and decreases bandwidth usage.

In another embodiment, the server implements additional modules that adjust the structure of the prompt sentence based on predicted complexity of the generative AI model's response. For users with sparse history data, the server reduces the number of constraints and requests more exploratory proposals, while for users with rich history and emotion data, the server increases the specificity of constraints and requested output structure. This non-conventional mechanism controls the internal computation pattern of the generative AI model through prompt engineering, which leads to more stable output distributions and reduces the likelihood of incomplete or malformed proposals, thereby reducing error handling overhead on the server.

In yet another embodiment, the server employs alternative generative AI models, such as encoder-decoder architectures or mixture-of-experts models, and adjusts the prompt sentence to include explicit tags or tokens that select appropriate expert components. The server can, for example, prepend tags such as “[MYSTERY_BOOKS]” or “[SCIENCE_DOCUMENTS]” to the prompt sentence to bias the model toward specialized internal sub-modules. This configuration allows the system to exploit model specialization while maintaining a unified prompt construction pipeline, thereby increasing recommendation accuracy without increasing latency significantly.

The terminal can implement optional emotion recognition on-device using a lightweight neural network trained for facial expression or voice tone analysis. The terminal processes camera frames and audio signals into low-dimensional emotion features and transmits only the features, not raw sensor data, to the server. This reduces network bandwidth, protects user privacy, and still provides sufficient input for the server's reaction tendency analysis. The combination of on-device pre-processing and server-side aggregation yields a distributed architecture that optimizes resource usage across devices.

In still another embodiment, the server supports multiple content domains, such as textual documents, audiovisual streams, and interactive media. The server maintains domain-specific feature subsets and domain-specific segments of prompt sentences, while sharing common user attribute and emotion representations. The server selects domain-specific templates according to a target content domain and merges them with common segments describing user reactions and exclusions. This modular template design allows the same generative AI model interface and the same underlying data structures to support multiple types of information items, which simplifies implementation and reduces storage redundancy.

Across these embodiments, the server, the terminal, and the user cooperate so that the generative AI model receives richly constrained, user-specific prompt sentences, and the resulting proposed information is immediately integrated into reservation and management operations. Because the system controls what data is included in the prompt sentence, how exclusion targets and prioritized targets are encoded, and how reservation states are stored and reused, the system achieves improved precision of recommendations, reduced processing overhead, and reduced communication load. The described structures and operations therefore constitute specific improvements to computer-implemented recommendation technology rather than mere abstract manipulation of information.

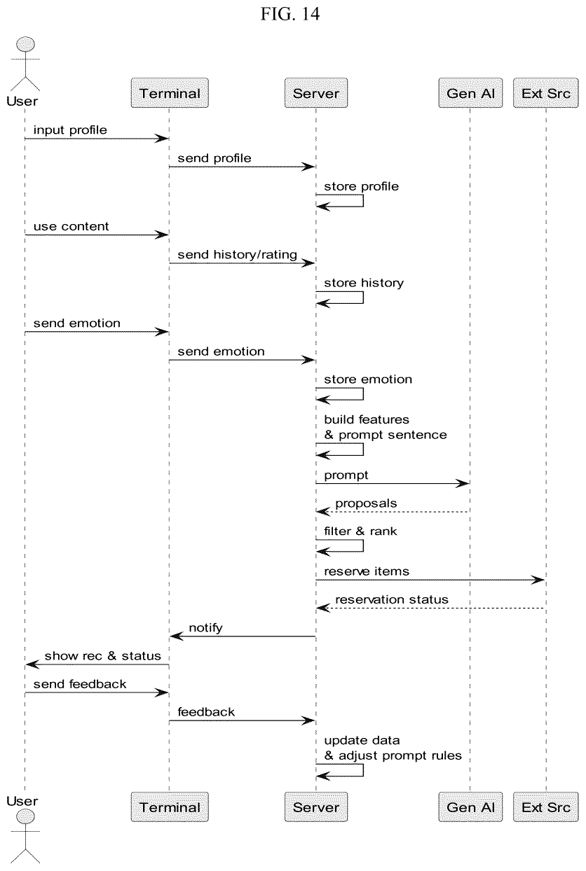

The following describes the processing flow using FIG. 14.
Step 1:

The user operates the terminal to input user attribute information and preference information. The terminal displays input fields for age, general interests, preferred categories, and other profile items, receives the user's entries as input, and generates a structured data object as output. The terminal converts free-text and selection inputs into normalized codes and key-value pairs and prepares a profile record suitable for transmission to the server.
Step 2:

The terminal transmits the structured profile record to the server. The input to this step is the profile record generated in Step 1, and the output is an HTTP request delivered to the server's application interface. The terminal encapsulates the profile record in a network message, assigns a user identifier, and sends the message via a secure communication protocol to the server.
Step 3:

The server receives the profile record and registers user attribute information and preference information in a storage medium. The input is the profile record from the terminal, and the output is one or more database records stored in user profile tables. The server parses the received data, validates field types and allowed values, maps fields to database columns, and executes insert or update operations so that the user's profile is persisted.
Step 4:

The user consumes information items using the terminal or external platforms, and the terminal records behavioral history events. The input is the user's interaction with content, such as starting, stopping, or finishing an item, and the output is a behavioral history event object. The terminal monitors content playback or reading actions, assigns content identifiers, timestamps the events, and encapsulates the events into a structured representation.
Step 5:

The terminal sends behavioral history information and, when available, evaluation information to the server. The input is a set of event objects containing content identifiers, actions, and optional ratings, and the output is a request received by the server containing these events. The terminal batches events when appropriate, compresses or serializes them, and transmits them to an event reception interface on the server.

### Step 6:

The server stores behavioral history information and evaluation information in corresponding tables and updates derived statistics. The input is the event batch from the terminal, and the output is updated records in history tables and aggregated fields. The server writes each event into a behavioral history table, updates cumulative counters and average ratings per user and per category, and maintains flags indicating whether items are fully consumed or partially consumed.
Step 7:

The terminal acquires emotion information related to information items and sends the emotion information to the server. The input is sensor data or explicit user selections indicating emotional reactions, and the output is an emotion record transmitted to the server. The terminal either processes camera and microphone signals through a local model to generate emotion scores or collects user-selected emotion labels, associates them with content identifiers and timestamps, and packages them into an emotion data structure for transmission.
Step 8:

The server registers emotion information and links it to behavioral history records. The input is the emotion data structure received from the terminal, and the output is one or more emotion table entries tied to specific information items and users. The server parses the emotion data, normalizes emotion scores to a standard scale, and stores them while updating indices that allow efficient retrieval of emotion per item and per category.
Step 9:

The server aggregates user-specific data into feature vectors and indexes. The input is the combination of stored user profile records, behavioral history records, evaluation records, and emotion records, and the output is a compact feature representation and lists of already-consumed and negative-reaction items. The server executes queries to collect relevant records, computes counts, averages, and weighted scores for each category, and assembles these numerical and categorical values into feature vectors. The server also constructs exclusion lists by collecting identifiers of items marked as consumed or associated with strong negative reactions.
Step 10:

The server selects template segments and constructs a prompt sentence for a generative AI model. The input is the feature vector, the exclusion lists, and representative positive-reaction items, and the output is a structured natural-language prompt sentence. The server chooses a suitable template according to the user's data density, inserts textual descriptions of the user's preferences and reactions, appends explicit lists of items to avoid, and includes instructions about the desired number and format of proposals. For example, the server generates a prompt such as: “The user is a 35-year-old reader who prefers mystery and fantasy books. The user has already read and enjoyed ‘Mystery Title A’ and ‘Fantasy Title B’. The user did not enjoy ‘Horror Title C’. Please propose ten new books that the user has not read yet, focusing on mystery and fantasy with a positive and exciting mood, and avoid books similar to ‘Horror Title C’. Provide the results as a list of titles, authors, and reasons.”
Step 11:

The server sends the prompt sentence to the generative AI model and obtains proposed information. The input is the constructed prompt sentence and model configuration parameters, and the output is a text sequence describing proposed information items. The server invokes a model interface, transmits the prompt as input tokens, configures generation options such as maximum length and sampling parameters, receives generated tokens from the model, and decodes the tokens into a human-readable list of proposals.

### Step 12:

The server parses the generated text to extract structured proposed information items. The input is the raw text produced by the generative AI model, and the output is a set of records each including at least a title field, a category field, and an explanation field. The server applies pattern recognition rules, such as detecting numbered lists or separators, divides the text into item segments, and extracts fields by splitting on predefined delimiters or by matching known patterns in the text.
Step 13:

The server filters the proposed information items based on already-consumed information and negative-reaction information. The input is the parsed item set and the exclusion lists created in Step 9, and the output is a reduced item set that excludes duplicates and disfavored items. The server compares identifiers or titles with entries in the behavioral history and management application data, removes any item that matches consumed or excluded content, and updates ranking scores to deprioritize borderline items.
Step 14:

The server forms a recommended information set and writes it to the storage medium. The input is the filtered item list and calculated ranking scores, and the output is a persistent recommended information record associated with the user. The server sorts the items according to relevance and diversity criteria, assigns internal identifiers to the recommendation set, and stores the recommendation set with metadata such as generation time and source prompt.
Step 15:

The server queries external information sources to map recommended items to external catalog entries. The input is the recommended information set containing titles and categories, and the output is a set of matched external identifiers and availability states. The server constructs search queries for each item, calls external catalog interfaces, receives candidate matches, evaluates similarity based on titles and categories, and selects the best match for each recommended item.
Step 16:

The server performs automatic acquisition reservation for matched items at external information sources. The input is the set of matched external identifiers along with user identifiers and desired acquisition parameters, and the output is reservation states for each item. The server constructs reservation requests, sends them through external communication interfaces, processes responses indicating reservation success, waitlist status, or failure, and stores the reservation states in the reservation table.
Step 17:

The server generates notification messages based on reservation states and recommendation content and sends the messages to the terminal. The input is the recommended information set and the corresponding reservation states, and the output is one or more notification messages delivered to the terminal. The server composes text such as “The book ‘Mystery Title A’ has been reserved and is available for pickup” or “The movie ‘Action Movie A’ has been added to your watchlist,” and uses a communication application interface to transmit these messages to the user's device.
Step 18:

The terminal receives notification messages and presents them to the user. The input is the message payload from the server, and the output is a display element or alert on the terminal. The terminal interprets the message content, formats it according to the user interface style, and shows the information item title, platform, and any relevant dates so that the user can act on the recommendation.
Step 19:

The user consumes reserved information items and optionally provides evaluation and explicit emotion feedback via the terminal. The input is the recommendation and reservation information observed by the user, and the output is evaluation and emotion entries entered into the terminal. The user selects rating values, chooses emotion categories, or types short comments, and confirms the entries through the client application's interface.
Step 20:

The terminal transmits evaluation information and explicit emotion information to the server. The input is the user's feedback data, and the output is a structured feedback object received by the server. The terminal attaches identifiers of the relevant information items, associates ratings and emotion labels with these identifiers, and sends the feedback object as a message to the server's feedback interface.

### Step 21:

The server updates evaluation records and emotion records with the new feedback and recalculates user reaction tendencies. The input is the feedback object from the terminal, and the output is updated evaluation table entries, updated emotion table entries, and new feature vector values. The server writes or modifies rating values and emotion scores, recomputes averages and weighted scores per category, updates flags indicating categories to avoid or prioritize, and stores the updated feature vectors.

### Step 22:

The server regenerates or adjusts prompt sentence templates for future recommendation cycles based on updated reaction tendencies. The input is the recalculated feature vector and reaction statistics, and the output is new template selection rules and modified text segments to be used in subsequent prompt sentences. The server may, for example, add a sentence indicating that a particular category should be avoided or remove constraints that are no longer applicable, thereby refining how future prompt sentences guide the generative AI model.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

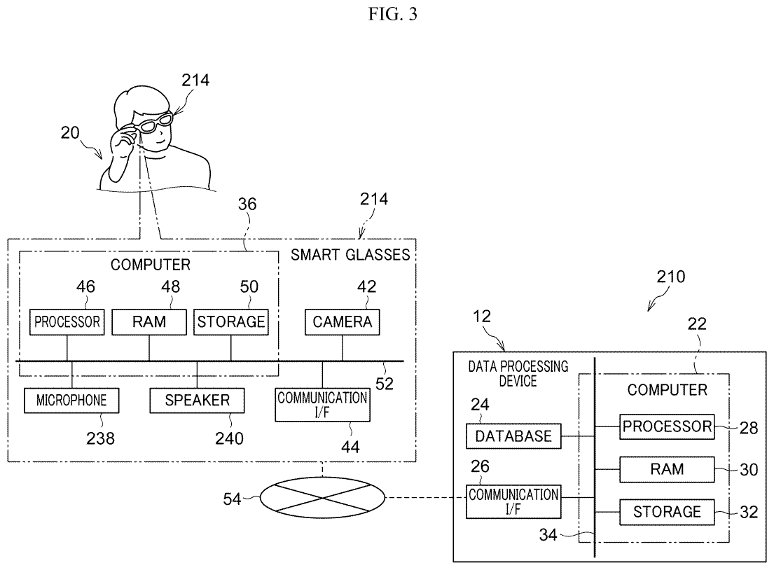

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

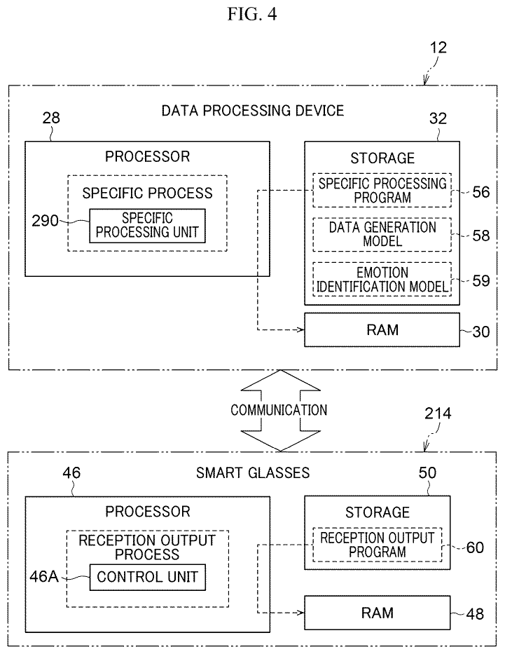

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

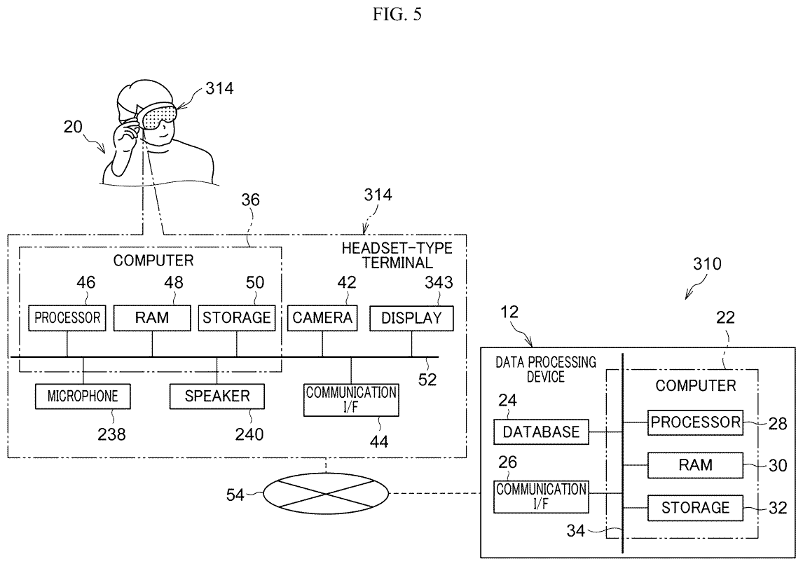

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

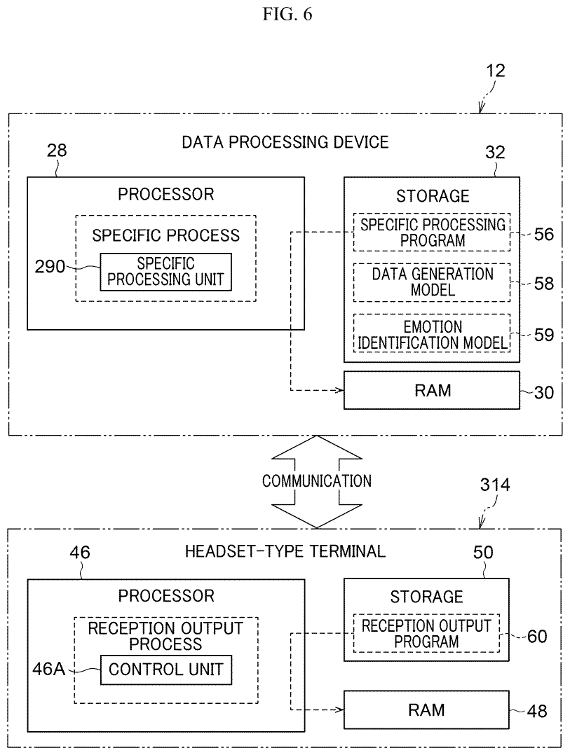

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

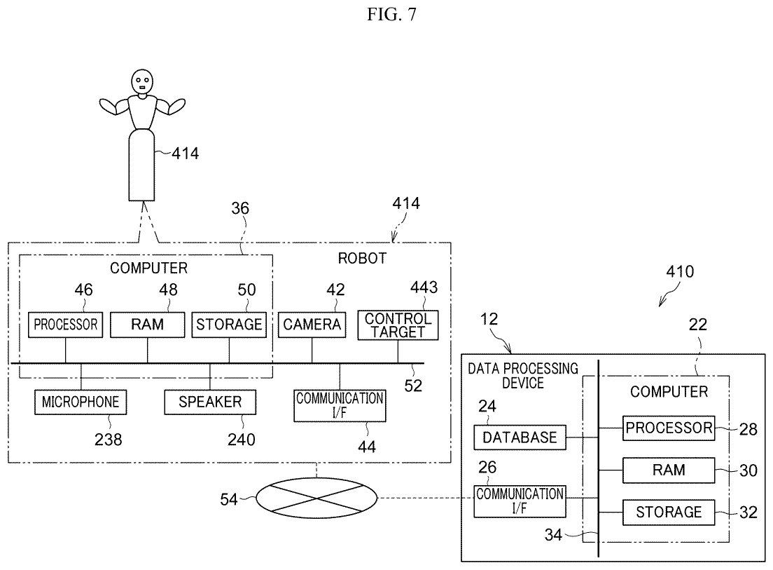

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

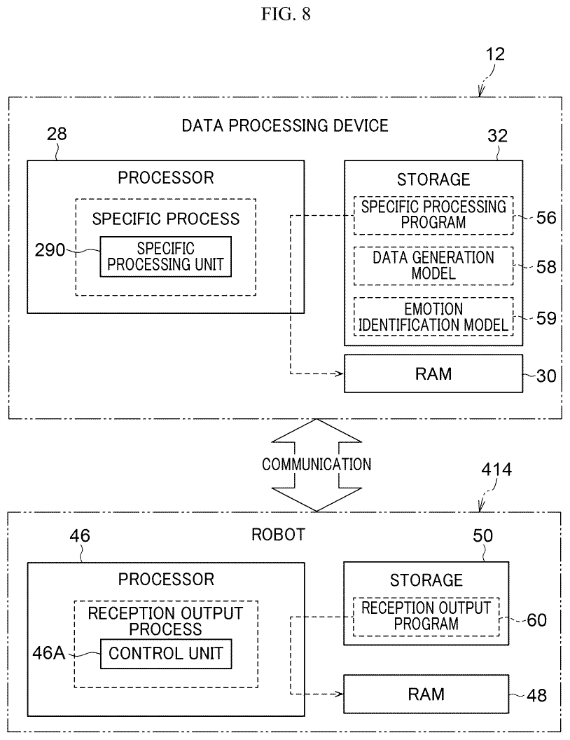

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

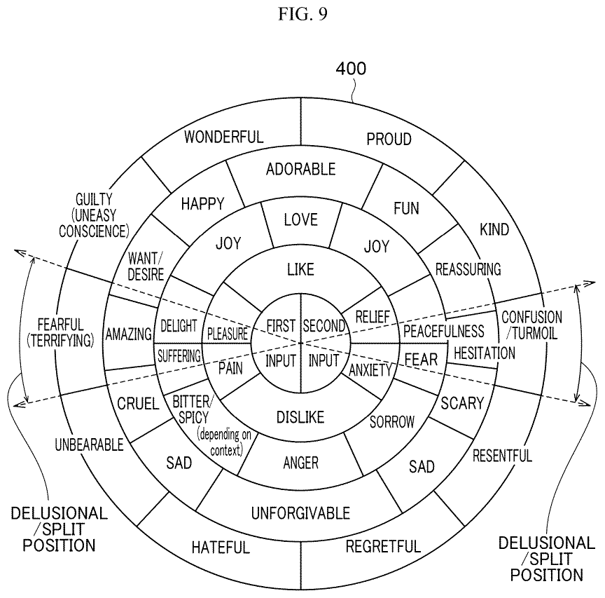

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

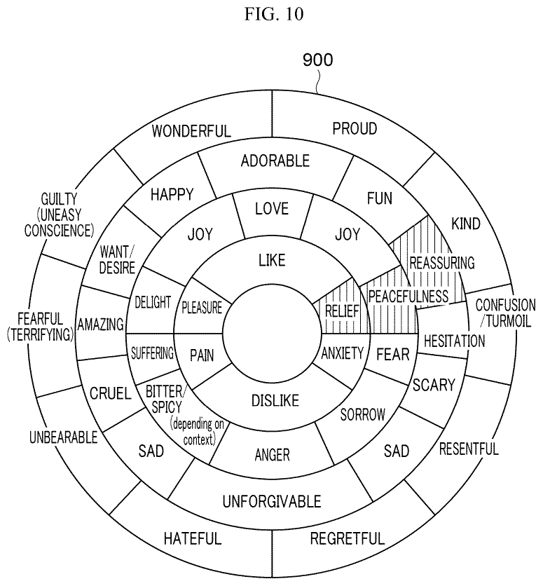

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, from a communication terminal, attribute information and preference information of a user, register the attribute information and the preference information in a storage device, recognize an emotional state of the user by using an emotion analysis function, and store emotion information representing the emotional state in association with the attribute information and the preference information in the storage device,
analyze the attribute information, the preference information, and the emotion information stored in the storage device, and automatically generate, based on an analysis result, a prompt sentence that describes at least part of the attribute information, the preference information, and the emotion information in a natural language as input data for a generative AI model,
transmit inquiry data including the prompt sentence to the generative AI model, acquire a generated result from the generative AI model, analyze the generated result, and generate, as structured data, a set of information candidates to be presented to the user,
automatically generate request data for causing an external information source to execute a reservation process or an acquisition process, based on identification information corresponding to each information candidate included in the set of information candidates, and communicate with the external information source to automatically execute the reservation process or the acquisition process,
register, as management information in the storage device, a result of the reservation process or the acquisition process acquired from the external information source, generate notification content to be presented to the user based on the management information and the set of information candidates,
and transmit the notification content to the communication terminal via a communication application, and
generate control information for excluding, from subsequent automatic generation of the prompt sentence and from subsequent information proposal by the generative AI model, at least one information candidate determined to be processed or viewed based on the management information, and control the information proposal by using the control information.

### (Supplementary 2)

The system according to supplementary 1,
wherein the processor is configured to
automatically register, in the storage device as the management information, reserved information or viewed information based on the result of the reservation process or the acquisition process acquired from the external information source, and change a constraint condition included in the prompt sentence for the generative AI model based on the management information, thereby excluding information corresponding to the reserved information or the viewed information from an information proposal by the generative AI model.

### (Supplementary 3)

The system according to supplementary 1,
wherein the processor is configured to
analyze behavior history information of the user and the management information accumulated in the storage device, dynamically change a description content and an output format of the prompt sentence based on the behavior history information, the attribute information, the preference information, and the emotion information, and control an information proposal by the generative AI model so as to preferentially propose information having high novelty to the user.

### Application Example 1

### (Supplementary 1)

A system comprising a processor,
wherein the processor is configured to
obtain attribute information and preference information of a user from a user terminal, and register the attribute information and the preference information in a data storage device,
analyze the registered attribute information and the registered preference information, generate a prompt sentence for a generative AI model on the basis of an analysis result and an emotional state of the user, and cause the generative AI model to generate proposal information by using the prompt sentence as input,
access, via a communication network, an external providing source that provides digital content corresponding to target content included in the generated proposal information, execute an automatic acquisition process of the target content at the external providing source, and make the target content available to the user terminal on the basis of a result of the automatic acquisition process,
notify completion information of the automatic acquisition process to the user terminal via a communication application,
record, in the data storage device, usage history information on the basis of an acquisition status and a usage status of the target content, and
identify already-acquired content or already-read content on the basis of the usage history information, and exclude the already-acquired content or the already-read content from proposal information to be generated by the generative AI model in a subsequent process.

### (Supplementary 2)

The system according to supplementary 1,
wherein the processor is configured to
generate the prompt sentence such that the prompt sentence includes constraint information including, as exclusion conditions, the already-acquired content or the already-read content identified on the basis of the usage history information in addition to the attribute information and the preference information of the user, and control the generative AI model so as to generate the proposal information in consideration of the exclusion conditions.

### (Supplementary 3)

The system according to supplementary 1,
wherein the processor is configured to
convert the proposal information generated by the generative AI model into structured data, add identification information and availability information in the external providing source to the structured data, and register the structured data in the data storage device as management information for executing the automatic acquisition process at the external providing source and an update process of the usage history information.

### Example 2

### (Supplementary 1)

A system comprising a processor,
wherein the processor is configured to
acquire user attribute information and preference information based on input from a communication terminal, and store the acquired user attribute information and preference information in an information storage device in association with past usage history of the user,
analyze the user attribute information, the preference information, and the past usage history stored in the information storage device, and generate a prompt sentence based on a result of the analysis,
the prompt sentence including a condition for excluding items already used or processed by the user,
a condition for selecting items that match a preference of the user, and an output format required for a generative AI model,
input the generated prompt sentence into the generative AI model that generates response information based on natural language processing, and acquire candidate information of recommendation targets generated by the generative AI model in accordance with the prompt sentence,
acquire external information regarding availability or provision status of the recommendation targets by performing communication processing with an external information providing apparatus for the acquired candidate information of the recommendation targets, and generate final recommendation information to be presented to the user by selecting the candidate information or by adding auxiliary information to the candidate information based on the external information,
transmit, based on the final recommendation information, a request for automatically performing a reservation or acquisition process for a recommendation target selected by the user to the external information providing apparatus, record a result of the reservation or acquisition process in the information storage device, and notify the communication terminal of the user of the result via a communication application,
manage, in the information storage device, items already used or processed by the user based on process status information acquired from the external information providing apparatus, and update management information for excluding the items already used or processed by the user from generation of the prompt sentence and from selection of recommendation targets by the generative AI model, and
update weighting of the user preference and recommendation conditions based on a selection history of the recommendation information by the user and on execution results of the reservation or acquisition process, and generate, as input to the generative AI model for a subsequent execution, an updated prompt sentence reflecting updated preference information and updated recommendation conditions so as to progressively improve recommendation accuracy.

### (Supplementary 2)

The system according to supplementary 1,
wherein the processor is configured to
automatically register, in a management application, information determined as already read, already viewed, or already used by the user based on the process status information acquired from the external information providing apparatus, and to control the generative AI model so as to automatically exclude the registered processed information from the candidate information of recommendation targets.

### (Supplementary 3)

The system according to supplementary 1,
wherein the processor is configured to
analyze history information of the user stored in the information storage device in a chronological and statistical manner, estimate a change in preference or a usage tendency of the user based on the history information, and reflect a result of the estimation as a condition for generating the prompt sentence so that the generative AI model generates recommendation targets having higher novelty.

### Application Example 2

### (Supplementary 1)

A system comprising a processor,
wherein the processor is configured to
receive user attribute information and preference information from a user terminal and register the user attribute information and the preference information in a storage medium,
collect and store user behavioral history information, evaluation information, and emotion information, and extract, based on the behavioral history information and the emotion information,
information items that represent positive user reactions and information items that represent negative user reactions for each user,
construct a prompt sentence to be used as an input to a generative AI model based on the attribute information, the preference information, the behavioral history information, the evaluation information, and the emotion information, and add to the prompt sentence instruction content including a condition to exclude information items already obtained by the user and the information items that represent negative user reactions, and a condition to prioritize information items similar to the information items that represent positive user reactions,
input the prompt sentence into the generative AI model, obtain proposed information output from the generative AI model, and generate a recommended information set by excluding, from the proposed information, the information items already obtained by the user and duplicate information items based on the behavioral history information and a management storage medium,
execute, for each information item included in the recommended information set, an automatic acquisition reservation process through a communication interface of an external information source, and register an obtained reservation state in the storage medium,
generate, based on the reservation state, a notification message for a user terminal and notify the user of the recommended information set and the reservation state via a communication application, and
receive an evaluation input or an explicit emotion input from the user, register the received input as the emotion information in the storage medium, and reflect the registered emotion information in subsequent construction of the prompt sentence so as to adjust proposed information in later executions.

### (Supplementary 2)

The system according to supplementary 1,
wherein the processor is configured to
register, based on acquisition completion information and return completion information obtained from the external information source, information items included in the recommended information set as already-consumed information in a management application storage medium, and specify the already-consumed information as exclusion targets in the prompt sentence input to the generative AI model so as to exclude the already-consumed information from information to be proposed by the generative AI model.

### (Supplementary 3)

The system according to supplementary 1,
wherein the processor is configured to
analyze the behavioral history information, the evaluation information, and the emotion information of the user to calculate reaction tendencies for different user attributes, and dynamically change contents and an output format of the prompt sentence using a calculation result so as to adjust types and priorities of proposed information obtained from the generative AI model and propose new information.

What is claimed is:

1. A system comprising:
circuitry configured to
receive, via a packet-switched network, attribute data and preference data associated with an entity, and store the attribute data and the preference data in a storage device,
compute a classification output by inputting sensor data or interaction data to a trained classification model, and store classification output data in association with the attribute data and the preference data in the storage device,
analyze the attribute data, the preference data, and the classification output data, and generate a prompt data sequence based on an analysis result,
input the generated prompt data sequence to a generative neural network model to acquire candidate output data,
transmit, via the packet-switched network, a processing request to an external data source based on identification information corresponding to the candidate output data, and receive a processing result from the external data source, and
generate notification data based on the processing result and the candidate output data, and transmit, via the packet-switched network, the notification data to a remote device for presentation.

2. The system according to claim 1, wherein the circuitry is further configured to register, in the storage device as tracking data, the processing result received from the external data source, and to generate control information for excluding, from subsequent generation of the prompt data sequence and from subsequent candidate output data, at least one candidate determined to have a processed status based on the tracking data.

3. The system according to claim 2, wherein the circuitry is further configured to modify a constraint condition included in the prompt data sequence based on the tracking data, thereby preventing the generative neural network model from generating candidate output data corresponding to previously processed candidates.

4. The system according to claim 3, wherein the candidate output data comprises a set of information candidates to be presented to a user, and wherein the processed status indicates that an information candidate has been reserved, acquired, or consumed at the external data source.

5. The system according to claim 4, wherein the external data source comprises at least one of a library reservation system and a digital content platform, and wherein the processing request comprises a reservation request or an acquisition request for a content item identified by the identification information.

6. The system according to claim 5, wherein the notification data comprises reservation completion information transmitted to the remote device via a communication application, and wherein the circuitry is further configured to register the reserved content item in a management application as a tracked item associated with the entity.

7. The system according to claim 6, wherein the trained classification model comprises an emotion analysis model configured to compute emotion category scores based on input data representing user utterances or interaction patterns, and wherein the classification output data comprises an emotion state vector indicating emotional tendencies of the user.

8. The system according to claim 1, wherein the circuitry is further configured to analyze historical interaction data associated with the entity stored in the storage device, the historical interaction data comprising at least selection history data, processing request history data, and consumption history data, and to generate the prompt data sequence further based on the historical interaction data.

9. The system according to claim 8, wherein the circuitry is further configured to compute a relevance score for each candidate in the candidate output data based on a comparison between the historical interaction data and attributes of the candidate, and to rank the candidates based on the computed relevance scores.

10. The system according to claim 9, wherein the circuitry is further configured to identify a pattern in the historical interaction data using a pattern recognition algorithm, and to adjust the prompt data sequence to bias the generative neural network model toward generating candidate output data aligned with the identified pattern.

11. The system according to claim 10, wherein the pattern comprises a temporal preference pattern indicating that the entity selects different categories of candidates at different time periods, and wherein the circuitry adjusts the prompt data sequence based on a current time period and the temporal preference pattern.

12. The system according to claim 1, wherein the circuitry is further configured to adjust the prompt data sequence based on the classification output data such that the candidate output data is modified in response to changes in the classification output, thereby dynamically adapting the candidate output data to a current state of the entity.

13. The system according to claim 12, wherein the adjusting comprises mapping the classification output data to a set of weighting parameters, and incorporating the weighting parameters into the prompt data sequence to bias the generative neural network model toward generating candidate output data corresponding to a detected state category.

14. The system according to claim 13, wherein the classification output data is updated periodically by re-inputting updated sensor data or updated interaction data to the trained classification model, and wherein the circuitry regenerates the prompt data sequence and acquires updated candidate output data in response to a change in the classification output data exceeding a predetermined threshold.

15. The system according to claim 1, wherein the generative neural network model comprises a transformer-based language model comprising a plurality of self-attention layers, and wherein the circuitry is further configured to transmit the prompt data sequence together with model inference parameters comprising at least a temperature parameter and a maximum output length to the generative neural network model.

16. The system according to claim 15, wherein the circuitry is further configured to parse the candidate output data received from the generative neural network model into structured data comprising a plurality of candidate records, each candidate record comprising at least a title field, a category field, and an identification field for use in generating the processing request.

17. The system according to claim 16, wherein the circuitry is further configured to validate each candidate record against a set of constraint parameters comprising a duplication constraint based on the tracking data and a relevance constraint based on the preference data, and to exclude candidate records that do not satisfy the constraint parameters from the notification data.

18. A system comprising:
circuitry configured to
receive, via a packet-switched network, attribute data and preference data associated with an entity, store the attribute data and the preference data in a storage device, and compute a classification output by inputting interaction data to a trained classification model,
analyze the attribute data, the preference data, and the classification output, and generate a prompt data sequence comprising an instruction portion and a constraint portion based on an analysis result, the constraint portion specifying exclusion of previously processed candidates based on tracking data stored in the storage device,
input the generated prompt data sequence to a generative neural network model comprising a transformer-based architecture to acquire candidate output data, and parse the candidate output data into structured candidate records,
transmit, via the packet-switched network, a processing request to an external data source based on identification information in the structured candidate records, receive a processing result, and register the processing result as tracking data in the storage device, and
generate notification data based on the processing result and the structured candidate records, and transmit the notification data via the packet-switched network to a remote device for presentation.

19. The system according to claim 18, wherein the circuitry is further configured to analyze historical interaction data associated with the entity to compute relevance scores for the structured candidate records, and to dynamically adjust the prompt data sequence in response to changes in the classification output exceeding a predetermined threshold.

20. A method performed by a system comprising circuitry, the method comprising:
receiving, via a packet-switched network, attribute data and preference data associated with an entity, and storing the attribute data and the preference data in a storage device;
computing a classification output by inputting sensor data or interaction data to a trained classification model, and storing classification output data in association with the attribute data and the preference data;
analyzing the attribute data, the preference data, and the classification output data, and generating a prompt data sequence based on an analysis result;
inputting the generated prompt data sequence to a generative neural network model to acquire candidate output data;
transmitting, via the packet-switched network, a processing request to an external data source based on identification information corresponding to the candidate output data, and receiving a processing result; and
generating notification data based on the processing result and the candidate output data, and transmitting the notification data to a remote device for presentation.
